(19) United States
(12) Patent Application Publication
(10) Pub. No.: US 2017/0033381 A1
(43) Pub. Date: Feb. 2, 2017

(54) Resource Tower

(71) Applicant: Thomas Michael Reilly, Kendall Park, NJ (US)

(72) Inventor: Thomas Michael Reilly, Kendall Park, NJ (US)

(21) Appl. No.: 14/812,406

(22) Filed: Jul. 29, 2015

(51) Int. Cl. H01M 8/0656; H01M 16/00; H02K 35/02; F01K 15/00; H02K 7/18

(52) U.S. Cl. CPC H01M 8/0656; F01K 15/00; H02K 7/1823; H02K 35/02; H01M 16/003; Y10S 74/09; H02K 53/00

(57) ABSTRACT

Invented is a Resource Tower that uses water electrolysis to separate out its elemental and purified H₂ hydrogen gas and O₂ oxygen gas. These gases form a pressurized flow for electricity generation for distribution and transport to heights atop the Resource Tower. Core advancements of this invention are the use of fuel cells at the top of the Resource Tower to electrochemically combine hydrogen gas and oxygen gas to produce electricity, heat, and water. The Resource Tower distributes the electricity, converts heat and water to steam to generate additional electricity for distribution, and ultimately coalesces the steam back to water at a height. The water that falls under acceleration of gravity from atop the Resource Tower is used to generate additional electricity for distribution. In addition to multiple sites of electricity generation for distribution, the purity of hydrogen gas and oxygen gas from water electrolysis is retained and the water resulting from the Resource Tower is purified and potable for distribution.

### CROSS-REFERENCE TO RELATED APPLICATIONS

Not Applicable.

### STATEMENT REGARDING FEDERALLY SPONSORED RESEARCH OR DEVELOPMENT

Not applicable.

### REFERENCE TO A SEQUENCE LISTING

Not Applicable.

### BACKGROUND OF THE INVENTION

Field of the Invention

Core to the invention is water electrolysis for purified H₂ hydrogen gas and O₂ Oxygen gas flowing upward past electricity generators to a height where the gases are electrochemically combined in fuel cells to form electricity, heat and indirect electricity, and water that flows under gravity from the height of the Resource Tower past electricity generators, and also delivers purified water, or resources from the tower.

Problem Statement

There is continued and growing concern about a lack of available and sustainable energy from all energy sources. Electricity is a dominate form of energy produced because of its versatility, current infrastructure, tailorability, and many other favorable properties. The production of electricity is currently dominated by hydraulic energy conversion, carbon based thermal energy conversion, and nuclear thermal energy conversion.

Electric production from natural or constructed hydraulic power sites is the most significant source of electric energy. Most facilities produce 1,000,000 kWh, it is the most efficient at 40-60% fluid power to electric power rates, it creates no harmful emissions, and is the lowest cost of power. Despite its many favorable attributes hydroelectric power is facing limitations. The most favorable natural or constructed hydroelectric power sites are largely already being used, and larger and less favorable dam locations are more expensive, have inherent risk, flood previously avoided animal habitats and migration routes, flood previously avoided human cultural and ancestral sites, often remove the most fertile agricultural lands, take about a decade to build, among other considerations. As the concerns about hydroelectric power start to equate to its benefits to many in society, there is increasing societal concern about dams resulting in stringent new construction and even destruction requirements.

Carbon based thermal power generation is a significant contributor to electrical energy supply. The over 560 plants operating at the time of filing produce on average 547,000 kWh with a 35% conversion of thermal power to electric power. Most thermal power is derived from burning coal with a few plants burning oil or gas as fuel. Although the efficiency of burning carbon based fuel has increased dramatically over the years, the debate over the availability and sustainability of coal, oils, and gas resources, as well as their environmental impact of carbon based emissions is getting louder making it difficult to invest in plant construction that take over 4 to 10 years to build before operations. At the time of filing the restrictions being placed on coal based thermal power generation is expected to result in the closure of many plants in the next months. Rising costs of these resources makes their cost greater than that of liquid power station and slightly lower than that of nuclear power station.

Thermal nuclear power generation can be a significant and even sole power source to a community in it proximity. Overall thermal nuclear power has not been permitted to make the contribution of which it is capable, especially given its comparable 40% thermal to electricity conversion rate and that there are no harmful environmental emissions from a properly operating thermal nuclear plant. The contribution of thermo nuclear electric power has been limited by social concerns about thermo nuclear power control and safety, disposal and storage of spent nuclear materials, the use of scarce supplies of radioactive fissionable material, combined with the investments over 4 to 8 years before operations, among other reasons.

Although thermal and hydraulic power production have served us well and will continue to serve society well for years to come, there are limits to their current as well as expanded use. The growing real and perceived limitations and disadvantages of these sources of energy are becoming more evident to societies worldwide. Further, as societies continue to flourish and advance, the demand for power generation continues to increase. The expected, yet unacceptable coming result, are modern societies experience brown-outs or reduced power periods, rationing, escalating costs, and other hardships that occur to the health and welfare of individuals, families, societies and economies.

The solution is seeking meaningful energy alternatives. To date alternatives have surfaced, but have proven inadequate in contributing to the magnitude needed to be a replacement energy source to thermal and hydraulic fluid power. At present there are small size power stations using wind energy, solar energy, geothermal, and alternative carbon based facilities. Even the most meaningful alternatives create only a negligible amount of energy production. They also suffer from location constraints, resource constraints, and can be intermittent such as with consistent wind and sun that can be dependent upon seasonal, time of day, weather, or other factors. Given these factors and usual energy conversion rates as low as 10%, the lengthy and high investment costs, too unpredictable energy production, and other reasons there yet remains a need for a meaningful energy supplement or replacement solution.

Water covers three-fourths of the earth's surface from a combination of oceans, seas, bays, and large to small internal bodies of inland water including man-made dams and reservoirs. There are numerous sources of flowing water but in total these remain small in comparison to stationary water. Recognizing the abundance and favorability of water as a source of energy has created a general movement in developing alternative energy captured or converted from the different characteristics associated with water. Water has a usable mass that creates a source of energy from hydrostatic pressure from a column of water or usable mass under conditions of water flow. As mentioned previously many of the most favorable or suitable locations for capturing energy from the flow of surface water have already been used and are therefore limited. Development is now moving towards exploring the energy capture or created by the movement of water from tidal or wave action and deep water currents. In many cases each of these are subject to astrological and climatologically conditions of time of season and time of day for tidal action, wind and sun consistency, and precipitation, as well as some influences upon ocean current change making the energy results of these attempts variable and unreliable.

Another natural state of water is in vapor form. A unique characteristic of water is its transition from one state to another under moderate conditions of nature bringing about its many useful and benevolent characteristics. In fact this cycle of water between liquid and vapor form are the natural processes of depositing water from a lower elevation to a higher elevation and imparting the useful kinetic and potential energy of water at elevated heights. The hydraulic forces of flowing water from elevated heights for water transport and work may be a primary facilitator of societies of all ages. Significant hydrostatic properties of water are also available from water mass and gravitational effects. The property of hydraulic pressure is

Other abundant and natural resources recognized by the current disclosure, from which to harvest energy, are that of hydrogen and oxygen. Hydrogen is more plentiful than any other element, making up about ¾ the mass of the universe. Helium is second, making up almost all of the remaining 25%. Oxygen is a distant third in the universe. However, on earth, oxygen is the most common element, making up about 47% of the earth's mass. As a fuel, hydrogen is available rarely in gas form, but is available from water, methanol, steam hydrocarbon reforming, gasification of low sulfur coal, among other methods.

The Resource Tower recognizes and then mimics the natural properties of water to be converted into a vapor and even into its hydrogen and oxygen components and rise in a natural and facile manner to heights. At height, the water vapor or water components of hydrogen and oxygen can be converted back to liquid water, but now water with kinetic and potential energy that will be manifest as a hydraulic force as the it flows downward. What is created is a mimic of a type of ecological system natural to the change of state of water from liquid to a gas and available to generate electricity and purified water. This cycle of liquid to gas to liquid may be configured as a self contained and water and gas recirculation system or may be configured to deliver purified and potable water as another resource of the Resource Tower. Important to the Resource Tower is scalability to create large systems capable of generating significant energy and water delivery to household or community systems. The environmentally neutral or potentially positive impact of the Resource Tower with the lack of pollutants or fossil fuel usage makes this acceptable for generations to come.

State of the Art Assessment

An assessment of the state of converting the latent energy found in the cycle of liquid water to gas to liquid water was undertaken. The following US patents and patent applications pertaining to energy generation from water flow, gas flow, fuel cells, and their combination are reviewed. It is noted that the citations discussed do not match the simplicity, scalability, and multiplicity of electricity generation of the Resource Tower for deployment potential to communities across the world. The following citations also do acknowledge the additional benefit of available purified potable water as is available from the Resource Tower. The Resource Tower provides novel and non-obvious advancements in electricity production and delivery of purified potable water.

WIPO Pub No. 2008/117284 A1 to David Cohen, IL, USA seeks to convert water into hydrogen and oxygen gas using an electrolysis unit located at ocean depth to gain the assistance of ocean pressure. Cohen's use of electrolysis under pressure is suggested despite acknowledgement that electrolysis is more efficient at atmospheric pressures. More specific to this publication is the statement of “said kinetic energy extraction unit is a rotary unit operated by buoyancy.” The definition and limitation to buoyancy is affirmed by “the kinetic energy of the bubbles due to their buoyancy may be used to operate an energy tapping mechanism” and “The wheel rotates upwards under influence of the gas and then the gas is released at the top.” A further limitation is that “wherein said gas recovery unit is provided with a valve to provide blasts of gas under pressure.” Clearly defined in the publication is energy extraction while the gas is entrapped in the water medium in bubble form, and then “the gas is released at the top” and captured for unstated uses. The Resource Tower advances an alternative to energy production that eliminates the mass and inertia associated with turning a rotary device in the presence of water. The Resource Tower uses kinetic and any available potential energy from gas expansion, gas flow, and associated pressure as a force for electricity generation while in its gas state, and specifically not while the gas is in a water medium. This gas state also facilitates the gas traveling to the top of the Resource Tower.

WIPO Pub No. 2012/143018 A2 to Ahmed Mohammed Ismail. Egypt and et. al., takes the Cohen application and extends it to its extremes. Mohammed discusses the formation of hydrogen and oxygen gases from electrolysis of water at the “depth of the sea” or the lowest earthly location. Then using “the rush strength of these two gases by the sea pressure” of the column of water above gas electrolysis production for electricity generation and to transport gases to “the most highest place, like mountain.” At these mountain heights, the gases are combined as “a fuel to turn thermal turbines to generate electricity or used as a fuel cell to generate electricity.” Further, “the combustion exhaust which is water vapor then condensing it and collecting the water resulting from the condensation in giant tanks.” This water is then taken “in pipes from the top of the mountain and let if fall free fall because of gravitation on turbines to generate electricity” and agricultural uses. The Resource Tower rejects the necessity of extremes in the “depth of the sea,” “the generated pressure is 3,742,888 atmospheric pressure,” “the rush strength of these two gases by the sea pressure,” “make gas emit automatically, which is hydrogen to the highest possible place, mount for example,” “the most highest place, like mountain,” “collect in giant tubs,” “water fall down freely from the top of the mountain to the bottom of the valley in pipes,” and more. Specific Mohammed teaches against non-sea pressure applications by stating “if the gas in the surface of the sea it will not gain pressure energy.” Again, the Resource Tower rejects the necessity of extreme conditions to innovate a novel and non-obvious globally deployable self-contained resource processor that eliminates the need for sea depths, mountain tops, and millions of pounds per square inch pressure to generate electricity, and if desired to provide potable water.

Water electrolysis is a preferred source of H₂ hydrogen in-situ supply that readily facilitates deployment of the Resource Tower to villages and communities of under developed and developed societies. Water electrolysis is advancing as a technology, but is only one of a limited number of other forms of providing hydrogen supply. The most appropriate commercially available hydrogen supply that can be deployed with the Resource Tower will be utilized that provides the least energy penalty, balanced cost, meets deployment demands, and other considerations. What is central to the disclosure of the Resource Tower is the presence of hydrogen, but the Resource Tower is indifferent by what means. Patent and patent application from the U.S. or foreign countries are available concerning advances in water electrolysis and other forms of hydrogen harvesting, but the supply of hydrogen is not an advancement of this disclosure. Examples of innovation for more efficient electrolysis electrodes are referred to below and will be included in information disclosures.

Electricity generation by the flow of hydrogen gas, oxygen gas, water, or their combination is central to the advancements disclosed by the Resource Tower. Claimed by the Resource Tower is the cycle of water to water in its elemental hydrogen gas and oxygen gas forms for gas flow electricity generation and transport to heights, from which the gases are electrochemically combined to produce electricity, and water now at height and flowing downward under acceleration by gravity to produce additional electricity. Patents, patent applications, and other publications address the design and function of gas and water electric generators, but except for the reciprocating electricity generator disclosed herein, this disclosure does not address electricity generator design and construction. The Resource Tower advances the presence and placement of electricity generation by upward flowing gases, steam expansion, and water flow, but the particular construction of the electricity generator is not contemplated by this disclosure. The Resource Tower will chose to use the most advanced electricity generators the market will offer to achieve the highest conversion from driving force to electricity production, balance of cost, deployment demands, and other considerations. An example of a commercially available gas flow electric generator is referred to in the detailed description and will be included in information disclosures.

Core to the Resource Tower is the electrochemical reaction of H₂ hydrogen and O₂ oxygen to harvest the highest direct conversion to electricity, highest heat recovery, and most efficient water removal. The purpose of the Resource Tower is the production of electricity and the benefit of purified and potable water. Among a limited number of types of devices to drive electrochemical combination of hydrogen gas and oxygen gas, fuel cells are the current preferred structural and medium catalyst and reaction vessel. The Resource Tower is concerned with the most efficient form of electrochemical electricity production but does not disclose or address the intricacies of what leads to the most efficient electricity production, minimizing heat formation, efficient capture of heat, water drainage, and other issues central to modern fuel cells, and other electrochemical reactors. Patents, patent applications, and other publications are left to address these matters. The Resource Tower will utilize the most appropriate commercially available electrochemical reactor, whether that is a fuel cell, or another leading technology. Examples of commercially available electrochemical reactors are referred to in the detailed description and will be included in information disclosures.

The Resource Tower discloses a best mode of gaining the greatest utility in the form of electricity by extracting energy from multiple sources available from water and its elemental components and molecular associations. As with many inventions, the advanced of the Resource Tower are achieved from a position of what is known to make advances into the realm of what is not previously known and utilized. The collective benefits brought by the Resource Tower are critical to the benefit of underdeveloped and developed villages and communities worldwide that all show demands for increases in electricity and potable water. As mentioned previously, conventional forms of electricity production are less feasible for new construction due to either limited in their place of use, too costly under current economic dynamics, and not seen as environmentally neutral enough to continue, among many other key reasons. Known forms of new and alternative energy production have proven to provide only a trivial contribution towards the real supplemental or alternative production need due to their own limitation of being intermittent, being costly, limited in area of deployment, often are climatologically influences, and many other reasons. The advancements of the Resource Tower to utilize the abundant resource of water and to extract energy from the molecularly level of water uninfluenced by other forces provides a predictable path for full supplemental or alternative electricity production needed, and the benefits that come with purified and potable water.

### BRIEF SUMMARY OF THE INVENTION

Briefly described, the invention comprises a tower configured to generate electricity and purified potable water resources. The Resource Tower is an elevating and support structure. Fundamentally it elevates an electrochemical reactor and the fuel and oxidant that are consumed by it. In general, the higher the tower the more electricity can be generated. Listed are the core aspects of the Resource Tower.

Water electrolysis will often be the preferred method of H2 hydrogen supply. The supply of H₂ hydrogen is the limiting factor of the Resource Tower. With the gas is required an oxidant provided by O₂ oxygen gas. The Resource Tower is indifferent as to the source of hydrogen gas, but as a preferred configuration, water electrolysis provides a means of generating in-situ purified hydrogen gas. Additionally, it naturally provides for purified oxidant or oxygen. The Resource Tower will however use the most efficient prevailing method of producing hydrogen gas, also dependent upon the location and demands of use. Hydrogen gas is produced at the cost of electrical energy to cleave the water molecule into its hydrogen and oxygen elemental components. A fundamental objective of the Resource Tower is to generate enough electricity to match this electricity consumption and produce a net abundance of electricity for use in villages and communities in under developed and developed societies.

Gas flow electricity production is key to the Resource Tower producing a net abundance of electricity. This demand for maximum electricity production is illustrated in the preferred apparatus configuration by including electricity generation at five points of energy extraction provided a phase of water or its elements as facilitated by Resource Tower. The Resource Tower maximizes the natural properties of each phase or element of water to extract the greatest energy potential at the least energy cost. On such is that gases can be easily and readily elevated to great heights with little, if any, energy penalty. Under pressure created by continuous production of large volumes of gas converted from liquid water, added heat to excite and further expand the pressure and flow rate of the gases, and by the negative pressure drawing the gas forward by consumption the hydrogen and oxygen gases provide another energy source for electricity production. Electricity is consumed by the water electrolyzer to form hydrogen and oxygen gases when in turn create a gas flow for the reciprocating electricity generators, gas flow generators, fuel cell electrochemical reaction from which emerge electricity, heat, and water. Indirectly by conversion of heat and water byproducts of the fuel cells to generate electricity by water vapor or steam expansion and then by the mass of water falling under the acceleration of gravity also contribute to the net production of Resource Tower electricity. The Resource Tower height depends on number of electricity generators needed in the path of gas flows and water flow to overcome the penalty of water electrolysis and the demands of the village and communities it is deployed to support.

Electrochemical reaction of hydrogen gas and oxygen gas as fuel and oxidant by fuel cells is another contributor to electricity production, as well as heat, and importantly water at an elevated height. Electricity is produced and is easily distributed from the Resource Tower. Heat is also produced at nearly equivalent levels as electricity and when captured for some form of use credits the fuel cell with conversion efficiencies of near and about 80%. The third product of the fuel cell and hydrogen gas and oxygen gas conversion is water. Combining the heat and water for steam expansion electricity production draws out the other contribution electricity and draws out the second portion of fuel cell efficiency.

Electricity generation by the flow of water is a primary reason for the height of the Resource Tower. The Resource Tower capitalizes upon the natural properties of water. The cycle from water to elemental hydrogen gas and oxygen gas components for effortless elevation to heights of essentially water, the reactive conversion of gases to water, then to water vapor or steam, and ultimately coalesced back to water to fall under the acceleration of gravity with the capacity to do work is the core and claim of the Resource Tower. The elevated electrochemical reactor for the production of water at a height positions water with its workable mass to then fall under the acceleration of gravity through water flow electric generators for additional electricity production.

Purified and potable water are another resource produced by the Resource Tower. Water electrolysis produces hydrogen gas and oxygen gas that separate from the dirty and briny source water. The purity of the hydrogen gas and oxygen gas is maintained throughout all processes of the Resource Tower. Ultimately, these pure gases are converted into electricity, heat, and pure and potable water. Under the fall of water from a height adds a water pressure to the potable water that adds to the viability of water as a resource from the Resource Tower.

The Resource Tower in an advancement in the efficient conversion of natural processes into electricity and potable water, where otherwise the means to do so may not exist. An unavailability due to a lack of adequate natural water flows, less than adequate availability of fuel sources, no access to energy that is environmentally neutral, are three among many reasons for lack of electricity. No less important is providing a source of purified and potable water, as so many diseases suffered across the world are transmitted by dirty water or improper hygiene facilitated by a lack of clean water. Even in developed areas such as California there is a shortage of potable water, but no shortage of sea water. The Resource Tower provides just such an environmentally neutral or potentially positive impact supplemental and even alternative electricity source and purified potable water source for the necessity and elevation of life of people in under resourced and underdeveloped and even developed villages and communities across the globe.

### BRIEF DESCRIPTION OF THE SEVERAL VIEWS OF THE DRAWING

The invention may be more fully understood by reference to the following drawings.

FIG. 1—Front view showing the Resource Tower's central inventive advances of using water and its phase change from liquid to elemental component gases for facile transport to elevated heights for phase change conversion back to water by fuel cell controlled gas electrochemical reaction producing electricity and purified water at height available to flow downward for additional electricity production and potable water use.

FIG. 2—Front view of the Resource Tower illustrating maximized fuel cell energy extraction by coproduction of direct electricity creation and indirect electricity production by heat reclamation directed to flash steam for additional electricity production:

FIG. 3—Front view of the Resource Tower showing a more full recognition of energy penalties and energy potential from water phase changes of liquid to elemental gases to liquid to vapor to liquid and use every natural character of each phase or component of water mass and mechanical flow, thermal, and chemical energy to produce a net electricity by multiple generators and purified water to contribute to the wellbeing of villages and communities as a supplemental or alternative electrical power and water source.

FIG. 4—A right-side view of the Resource Tower that most significantly clarifies the relationship of fuel cell thermal recovery and conversion to steam electricity generation at the top of the Resource Tower and a chosen spatial relationship and interconnectivity of the hydrogen-oxygen conjoined reciprocating electricity generators.

FIG. 5—A flow diagram of FIG. 3 that depicting the phase change of water and relationship of liquid, elemental gases, vapor, and liquid to the energy penalty water electrolysis and the net electricity production from energy sources derived from gas, electrochemical, thermal and vapor, and gravitational forces, as well as and delivery of purified potable water

FIG. 6—A flow diagram of FIG. 2 that depicting the phase change of water and relationship of liquid, elemental gases, vapor, and liquid to the energy penalty water electrolysis and the net electricity production from energy sources derived from electrochemical, thermal and vapor, and gravitational forces, as well as and delivery of purified potable water

FIG. 7—A flow diagram of FIG. 1 that depicting the phase change of water and relationship of liquid, elemental gases, vapor, and liquid to the energy penalty water electrolysis and the net electricity production from energy sources derived from electrochemical and gravitational forces, as well as and delivery of purified potable water

FIG. 8—The left-side view of the hydrogen-oxygen conjoined reciprocating electricity generator showing key features of the larger hydrogen reciprocating electricity generator to accommodate a double volume of hydrogen gas to the single volume of oxygen gas, as well as the strong magnetic piston and conductive coil construction central to electricity production.

FIG. 9—A flow diagram illustrating the primary components for the control of the hydrogen-oxygen conjoined reciprocal electricity generators for the first half, or cycle A, of its oscillation operation and electricity generation for distribution to the internal electricity network and positive displacement pressure of hydrogen gas and oxygen gas throughout the Resource Tower.

FIG. 10—A flow diagram illustrating the primary components for the control of the hydrogen-oxygen conjoined reciprocal electricity generators for the second half, or cycle B, of its oscillation operation and electricity generation for distribution to the internal electricity network and positive displacement pressure of hydrogen gas and oxygen gas throughout the Resource Tower.

### DETAILED DESCRIPTION OF THE INVENTION

### Principles of the Invention

H₂ hydrogen gas supply is the limiting raw material of the Resource Tower. In contrast there is a natural abundance of readily available atmospheric oxygen of sufficient purity as the second key raw material. A core advancement of this disclosure is the exploitation of the natural properties of near effortlessly delivers large volumes and high flow rates of hydrogen gas and oxygen gas to any height of atop a Resource Tower. The advancement is essentially the effortless delivery of water in its elemental hydrogen gas and oxygen gas forms. With hydrogen directed to the top of the Resource Tower, under the right conditions and in combination with oxygen, there is spontaneous exothermic electrochemical reaction to form an electric charge release, heat, and water. Central to elevating the electrochemical reactor to the top of the Resource Tower is the formation of water at height. Water with its mass and then acceleration under gravity to form hydraulic pressure provides an additional natural source of energy from which electricity can be generated.

Electrolysis is often a first consideration when looking for a method of producing hydrogen gas. In situ water electrolysis for the supply of high purity hydrogen gas and additionally high purity oxygen facilitates the Resource Tower to be deployed and benefit to essentially any electricity deficient village or community of the world Electrolysis of water leads to its decomposition by way of a reduction and oxidation reactions.

Water is oxidized at the anode to produce oxygen in the form of O₂ gas.

2H₂O→O₂+4H⁺+4e⁻

Water is reduced at the cathode to produce hydrogen in the form of 2H₂ gas.

4H₂O+4e⁻→2H₂+4OH⁻

Water electrolysis innovation is not the focus of the Resource Tower, but the novel and non-obvious combination of electrolysis as an integral component in a system with an elevated fuel cell and associated gas pressure powered electric generator(s) and water powered electric generator(s). The most important consideration for the Resource Tower is the production of hydrogen by any means. When looking to the production of hydrogen by water electrolysis, the primary consideration is the efficiency and volume of hydrogen production to energy required for the decomposition of water. A review of patents, patent applications, and published literature show a handful of electrolysis innovations driven largely by the automotive industry, and of course other concerns. One example of a leading technology by QuantumSphere, CA, USA is a NiFe (nickle and iron) nano particle coating to create an ultra-high surface area conductor (UHSAC) coated on electrodes that increases surface areas by over 1000 times. When applied to an electrolysis hydrogen generator it is reported to increase hydrogen production by 300% at the same energy input. Another example of a leading technology by GridShift, Inc., GA, USA called the “electrolyer” or a nano particle creating an ultra-high surface area conductor (UHSAC) on a uniquely shaped electrode. These UHSAC electrodes report advantages enabling smaller electrolysis hydrogen generators than currently available, offers over 95% lower electrode cost, operate at 85% energy conversion efficiency, and while producing 4 times the amount of hydrogen. A third method emerging is the use of ultrasonic vibration with electrolyzers. On such report by Salman Hassan Zadeh of the University of Birmingham, UK showed increased efficiency by 4.5% consistent with other literature showing 5%-18% and has secondary benefits of reduced electrode degradation. Resource Tower will incorporate any leading and affordable hydrogen generator technology or their combination, as well as just hydrogen supply that meets the efficiency, volume, and cost requirements of the particular Resource Tower application scenario. The Resource Tower incorporates the hydrogen supply, but is not so much interested in how the hydrogen is made available. A current best mode of the Resource Tower will incorporate a hydrogen electrolyzer.

The molecular expansion of H₂ hydrogen gas and O₂ oxygen gas from liquid water is a significant driving force capitalized upon by the Resource Tower. As previously shown water is composed of two hydrogen atoms and one oxygen atom. An abbreviation of a known derivation follows to show the significant energy potential available as a driving force from the expansion of gas from liquid water.

H₂O→H₂+O

H=1.00794 grams/mole O=15.9994 grams/mole

18.015 grams/mole=2·(1.00794 g/m)+15.9994 grams/mole

1 liter of water=1000 grams of water

(1000 grams water)/(18.015 grams/mole)=55.5093 moles of water

Moles of hydrogen or 2H=2·(55.509 moles)=111.018 moles

Moles of Oxygen=55.509 moles

To gain the volume of the gases, turn to the most common form of the ideal gas equation

PV=nRT
at standard temperature and pressure (STP)
   P—Pressure of the gas (1 atmosphere at sea level)
   V—Volume of the gas
   n—Number of moles of gas
   R—0.08205784 (liter·atmosphere)/(mole·temperature)
   T—Temperature of the gas (22 Celsius or 295 Kelvin)

V=nRT/P

Hydrogen V=(111.018 mol)·(0.08205784 (liter·atm)/(mol·K))·(295 K)/1 atm 2687.42 liters of hydrogen per 1 liter of water

Oxygen V=(55.509 mol)·(0.08205784 (liter·atm)/(mol·K))·(295 K)/1 atm 1343.71 liters of oxygen per 1 liter of water

Found is that one liter of water will produce 2,687 liters of hydrogen and 1,344 liters of oxygen at one atmosphere pressure and room temperatures. Gas volumes will vary some with increased pressure to drive gas flow electricity generators, but what is important is the observation of the magnitude in change from water to elemental hydrogen gas and oxygen gas. The continual production and conversion of water to a fuel and oxidant as well as a large volume of gas forms a solid foundation of the Resource Tower for multiple point of extraction of electricity and purified water.

Expansion of hydrogen gas and oxygen gas resulting in flow and pressure as potential source of energy and its efficient use for electricity generation is an important consideration of the Resource. As with electrolyzers and fuel cells, generators are also experiencing an evolution in efficiency. As an example EXRO Technologies has published the development of their Dynamic Current Management (DCM) generator that operates at a modest 300 rpms to produce a relatively constant power output at 83% efficiency, regardless of a change in load from 5 to 150 ohms tested. The key to the efficiency of this device is managing off-peak losses by creating multiple design point from which the generator can operate at peak performance. Overall, this is an example of current state of technology that achieved more than 65% improvement in performance over systems without off-peak loss management. At another extreme in the ETH Zurich innovation of electric power generation is the 500,000 rpm matchbox sized turbine operating at 95% gas utilization. The Resource Tower will utilize gas flow and water flow electric generator(s) that are available with the highest efficiency in electric generation balanced by capacity, cost, and other factors specific to the demands of the Resource Tower. A current best mode of the Resource Tower will use the terms gas flow and water flow generators to denote a best practice configuration.

The electrochemical H₂ hydrogen gas and O₂ oxygen gas reactor positioned at some height atop the Resource Tower is a key advancement of this disclosure. Yet, like hydrogen and oxygen production, the Resource Tower is not claiming an innovation in fuel cells or other conversion, combustion, or other methods of extracting energy and creating a water by product. The Resource Tower will incorporate the most efficient innovation using hydrogen and oxygen as reactants or fuel for generation of electricity and water, and secondarily that such water is potable and environmentally benevolent water. The electrochemical reactions at the fuel cell are naturally similar to those of electrolysis.

At the fuel cell oxidation reaction at the anode is

2H₂+2O²⁻→2H₂O+4e⁻

The reduction reaction at the fuel cell cathode is

O₂+4e⁻→2O²⁻

The net redox reaction shows the consumption of hydrogen and oxygen to produce water

2H₂+O₂→2H₂O

Water and heat are primary products of the above electrochemical reactions. The amount of heat produced varies by fuel cell construction with a primary contributor being the system electrolyte. When heat is captured for improved efficiency of the fuel cell or other associated system, the efficiency of the fuel cell is among the highest of energy producing options. For instance: water turbine (up to 90%, practically achieved), Fuel cell (up to 85%), gas turbine plus steam turbine (combined cycle up to 60%), and gas turbine (up to 40%). There are other technologies with high theoretical efficiencies that have yet to approach those limits, such as wind turbine (up to 59%, theoretical limit) and solar cells (15% most often, 85-90% theoretical limit). An excellent example of current applied fuel cell innovation in a stationary application, such as the Resource Tower, there is the Panasonic Ene-Farm Home Fuel Cell showing electrical efficiency (Low Heat Value, LHV)) of 40%, thermal efficiency (LHV) of 50%, and a total efficiency (LHV) of 90%. Low Heat Value (LHV) is the net resulting energy of energy available for work after any losses. This efficiency natural gas to electrical energy conversion is about right for other published limits of 50%. The use of H2 Hydrogen and O2 oxygen efficiency is more in line with 60%-70% electrical efficiency as normally achieved between atmospheric temperature to 90° C. The unit converts natural gas into electrical energy and hot water for a single residence. The Resource Tower will utilize hydrogen and oxygen as fuels or reactants with any generator that produces the most efficient electrical energy at the needed efficiency, cost, and other considerations for situational demands of the Resource Tower.

Energized water vapor steam, steam vapor, or steam production and expansion as a source of energy has been discussed as one application of the fuel cell thermal energy. It is seen that the efficiency of the fuel cell fully emerges with coproduction in place. That is production of direct electricity and then the full utilization of heat for direct or indirect useful purposes. Electricity production is the focus of the Resource Tower, making indirect coproduction of electricity from the fuel cell thermal energy a key priority. As such, the selection and use of fuel cells will also be contingent in large part upon the fuel cell's useful magnitude of heat. The use of heat for production of electricity occurs from electricity generation to use of thermal energy to raise system efficiencies. These heat management systems are considered integral to the overall fuel cell and only the use of excess presented heat is of innovative importance to the Resource Tower. The ideal fuel cell will efficiently convert hydrogen gas and oxygen gas to the largest proportion of electricity and the least amount of heat. Never the less, only a given amount of electrons are released per ionic pairs and given that the fuel cell is facilitating an exothermic electrochemical reaction part of the energy of the reaction is going to be released as heat. The amount of heat varies by fuel cell type and this is a consideration for a Resource Tower configured to capture the reaction heat to combine with by product water for the production of energized water vapor steam, steam vapor, or steam. Some examples of fuel cells that widely known to vary in their operating temperature are listed in the following table. The efficiency of converting heat to steam power in more efficient steam powered generators

| | | Operating | Electrical | Fuel and | Energy |
|---|---|---|---|---|---|
| Fuel Cell | Electrolyte | Temperature | Efficiency | Oxidant | Output |
| Alkaline | Potassium | 25 C. to 90 C. | 60%-70% | H₂ O₂, | 0.3 W-5 KW |
| | Hydroxide | | | | |
| | Solution | | | | |
| Proton | Proton | 25 C.-80 C. | 40%-60% | H₂ O₂, Air, | 1 KW |
| Exchange | Exchange | | | | |
| Membrane | Membrane | | | | |
| Phosphoric | Phosphoric | 180 C.-220 C. | 55% | H₂ O₂, Air, | 200 KW |
| Acid | Acid | | | Natural Gas | |
| Molten | Molten | 620 C.-660 C. | 65% | H₂ O₂, Air, | 2 MW-100 MW |
| Carbonate | Mixture of | | | Natural Gas | |
| | Alkali Metal | | | | |
| | Carbonates | | | | |
| Solid Oxide | Oxide Ion | 800 C.-1000 C. | 60%-65% | H₂ O₂, Air, | 100 KW |
| | Conducting | | | Natural Gas | |
| | Ceramic | | | | |

Fuel Cells, Jonathan E Bachman, wiki.uiowa.edu/display/greenergy/Fuel+Cells, Apr. 20, 2015

is argued around 30%. The contribution of steam expansion driven electricity is not intended to be a primary source of electricity generation of the Resource Tower, but fuel cell temperatures and immediately available water make fuel cell coproduction of electricity practical and prudent. Like the formation and expansion of hydrogen gas and oxygen gas to multiples of the volume of initial water volume, steam provide a similar benefit and can be seen by similar calculations.

H₂O→H₂+O

H=1.00794 grams/mole O=15.9994 grams/mole

18.015 grams/mole=2·(1.00794 g/m)+15.9994 grams/mole

1 liter of water=1000 grams of water

(1000 grams water)/(18.015 grams/mole)=55.5093 moles of water

To gain the volume of the gases, turn to the most common form of the ideal gas equation

PV=nRT
at standard temperature and pressure (STP)
   P—Pressure of the gas (vapor) (1 atmosphere at sea level)
   V—Volume of the gas (vapor)
   n—Number of moles of gas (vapor)
   R—0.08205784 (liter·atmosphere)/(mole·temperature)
   T—Temperature of the gas (vapor—steam at 100 Celsius or 395 Kelvin)

V=nRT/P

Steam Vapor V=(55.509 mol)·(0.08205784 (liter·atm)/(mol·K))·(395 K)/1 atm 1799.20 liters of steam vapor per 1 liter of water

Water at 100 degrees Celsius flashes into steam at one atmosphere and rapidly and forcefully expands 1800 times with the capacity to power electricity generation. The availability of heat sufficient to create steam injected across separated high surface area water provide for the creation of water vapor and expansion of that vapor through electricity generators for additional electricity contribution and to fully utilize the energy capacity of the fuel cell.

Reclaimed heat after steam vapor utilization is an important secondary consideration. Steam degrades rapidly after use and in the process of coalescing into droplets and water, it releases its heat energy. The capture of this heat is then transferred to an air or liquid medium for the thermal energy to be distributed about the Resource Tower to improve efficiencies. One such application is the heating of hydrogen gas and oxygen gas as they traverse the conduit to gain additional excitation and resulting pressure and flow rate. This added heat ensures electricity capable pressures and flow rates through the length of the hydrogen gas and oxygen gas conduits and delivery to the greatest heights required of the Resource Tower. An additional contribution of the thermal energy is deposit and achieved thermal equilibrium of the electrolyzer thermal catalyst. What is required in electrolysis is the input of 237 KJ/mol of water. That energy threshold can be contributed to by thermal energy as well as electrical energy. Any thermal energy provided to the electrolyte solution will assist in overcoming the molecular bond strength, but will also improve system efficiency by improving ion diffusion and other processes. Water electrolysis in a production environment may operate under the following conditions.
Energy Requirement—237 KJ/mol water
Cell Voltage—1.23V-1.48V possible,
   1.50V-1.70V common^{†}, and
   1.85V-2.05V industrially^{‡}
Cell Current—4-5 KWh/m3 of hydrogen
Pressure—Can be slightly elevated pressure
Temperature—70 C-90 C usual
Purity—99.8% and more hydrogen gas and oxygen gas.
†—Electrolysis of Water, Martin Chaplin, http://www1.lsbu.ac.uk/water/electrolysis.html, Apr. 22, 2015.
‡—A REVIEW ON WATER ELECTROLYSIS, Emmanuel Zoulias, et. al., http://www.cres.gr/kape/publications/papers/dimosieyseis/ydrogen/A20REVIEW%20ON%20WATER%20ELECTROLYSIS.pdf, Apr. 22, 2015.
   The Resource Tower is not specifically addressing heat extraction which is an integral design element of the fuel cell, but the use of extracted heat as described above for steam generation as well as adding thermal energy for systems efficiencies.

Water formation at the top of the Resource Tower is central to delivery of hydrogen gas and oxygen gas to the top of the Resource Tower by their electrochemical combination, consumption, or combustion. With sufficient height, the water gains two properties that create an energy driving force for conversion to electricity generation.

Mass and acceleration, and they can be significant.

1 liter=10 centimeters (cm)×10 cm×10 cm=10 cm³
10 centimeters=3.93 inches or ˜4 inch drain pipe
or a 4 inch pipe with about a 4 inch plug of water
or a 10 cm diameter piper with about a 1 liter volume of water every 10 centimeter.

1 liter of water=1000 grams=1 kilograms

A 10 meter fall=1000 centimeters (cm)=32.81 feet

1000 cm/10 cm=100 liters of water

1 kilograms/liter×100 liters=100 kilograms of water mass

The mass of a column of water about 10 centimeters (3.93 inches) in diameter or a 10 centimeter pipe contains about 1 liter of water every 10 centimeters (3.93 inches). At 10 meter (32.81 feet) intervals, the mass of water acting on a water flow generator is about 100 kilograms. That is 100 kilograms every 10 meters of Resource Tower Height.
The weight of water is the force of gravity acting on water.

Weight=Mass·Acceleration=Mass·Gravity

Mass of water=1 liter of water=1 kilogram

Acceleration or Gravity=9.8 Newtons/kilogram

1 liter of water (1 kilogram)·9.8 Newtons/kilogram=9.8 (kg·m)/s²

100 kg·9.8 N/kg=980 N

1 N=0.224808943 Pounds Force (lbf)

980 Newtons=220.31 pounds of force.

Electricity generator designs vary from 1000 MWatt turbines to streamlet paddles. The forces described above are well sufficient to drive electricity generation with an appropriately scaled electricity generator and one or more electricity generators through the drop and flow or water from the top of the Resource Tower. are simply representative of the capability on the scale of a liter of water and associated column of water at a distance of possible water flow electricity generator placement. This simple example allows for extrapolation to two liters, four liters, etc. The addition of electric generation by hydrogen and oxygen gases under pressure moving up the tower and passing gas flow electric generators, provides for two additional electric energy sources to overcome inefficiencies of any one and the combination of electric generation devices to create a net surplus of power generation. This disclosure demonstrates its interest in the use of collected water after the fuel cell or after steam degradation. The various publications concerned with the intimate scavenging of water from the fuel cell and storage within the fuel cell are not material to this disclosure. The Resource Tower is focused on the collection and transfer of volumes of hydrogen gas, oxygen, gas, heat, steam, and water for a continuous flow for the generation of reliable and continuous electricity.

Briefly treat has been the principles underlying the Resource Tower. The fundamental advancements of extracting energy from multiple sources associated with water, water phase change, elemental components or water, vapor and steam, and liquid water again have been incorporated in the above disclosure. Water is the most readily available resource on earth and 40% of the global population lives within 100 kilometers of the coast, and 44% within 150 kilometers. The Resource Tower cleverly uses water to access multiple sources of energy in a close recirculation configuration or an open configuration that also delivers purified and potable water as a useful resource. The Resource Tower capitalized upon the near effortless movement of hydrogen gas and oxygen gas for electricity generation and transport to heights, with a primary purpose of delivering volumes of water to a height with little energy penalty. The fall of that water from atop the Resource Tower provides additional electricity to offset the threshold of energy consumption to operate the Resource Tower and to provide net electricity and purified water to the villages and communities of under developed and developed communities across the globe, and do so in an environmentally neutral or potentially positive impact manner.

### Examples and Narrative Description

The Resource Tower is substantially constructed to support one or more H₂ hydrogen gas to O₂ oxygen gas reactors. Said reactors may include reciprocating combustion engines, turbine combustion engines, fuel cells, or other mechanism capable of converting elements of water from hydrogen gas and oxygen gas (as a byproduct of H₂ production or from air) into liquid water while simultaneously producing an electric energy output. As a best mode, one or more fuel cells are used to produce electricity, heat, and water. As water having mass with capability of doing work is formed at a height, there is potential for additional energy production with water falling through electricity generators. The height of the Resource Tower is sufficient that the combined electrical energy produced from the fuel cell and fall of water is equivalent or greater than the energy required to operate controls and produce more hydrogen gas. In a closed system at near equilibrium, the energy tower is capable of sustaining electricity production with little outside energy, water, or other resources.

By converting dirty or briny water in the electrolyzer is usually viewed as associated with a high energy penalty. An offset to that energy penalty for the Resource Tower is the realization that a gas flows nearly effortlessly in any direction to include upward at great heights. The flow of hydrogen gas and oxygen gas occurs by a positive pressure created with continuous operation of the electrolyzer that continuously produces more double volumes of hydrogen gas and more single volumes of oxygen gas. To be described next is the consumption of hydrogen gas and oxygen gas creating a negative pressure that draws the gas upward. The offset of energy used in the electrolyzer to create the hydrogen gas fuel is the transport of ultimately liquid water to great heights without an energy penalty. There are a limited number of hydrogen gas and oxygen gas reactors for producing electricity and water as a byproduct to mount at the top of the Resource Tower.

The operation of the fundamental structure and system of the Resource Tower provides additional potential for electrical energy generation. Fundamentally, the fuel cells are positioned on top of a tower so as to form water at a height that the fall of water through electrical generators will contribute to a neutral and even net production of electricity. To create a sufficient volume of water to produce needed electrical generation upon release is to require sufficient volumes of hydrogen gas and oxygen gas delivered to the top of the tower. For the availability of one ton of water or one cubic meter of water to fall through the Resource Tower requires that one ton or one cubic meter of water must be converted to its elemental hydrogen and oxygen gas forms and transported to the top of the Resource Tower. Straightforward enough as water is the most abundant element on the earth's surface and breaking it into its hydrogen and oxygen gas forms readily allows moving the equivalent of a ton of water in its elemental gas form from the base of the Resource Tower to the top where it is consumed or converted to water, heat, and electricity. The benefit of this cyclical process from water to gas to water is that the change of state from liquid water to elemental gases creates a voluminous change. The expansion from water to gas creates gas pressure and flow sufficient to move by conduits past electricity generators and the way to the top of the Resource Tower. As a best mode the production of hydrogen and oxygen gas by the electrolysis of water rather than the use of methane and associated chemistries. Although electrolysis requires a significant consumption of energy, the multiple forms of energy production and recovery by the Resource Tower provide for a net energy production with an environmentally neutral impact.

As stated previously, the use of a hydrogen and oxygen reactor or a hydrogen and oxygen fuel cell produces electricity, water, and heat. In making the choice of fuel cell is a consideration of the temperature at which it operates and the waste heat that is produced. Under conditions of coproduction or where electrical and thermal energy is optimally captured and used, the fuel cell is one of the most efficient forms of energy available. The Resource Tower captures the thermal energy produced from the fuel cell and combines it with water produced from the fuel cell to create another change of state of water from liquid to vapor. The resulting expansion and acceleration of steam is well known for its capacity to drive electrical generators. The Resource Tower is not done maximizing every source of energy from its design. At this point the steam is rapidly changed back to water and allowed to fall through the water flow electricity generators as previously mentioned. Further, the remaining, degraded, yet sufficient heated hair from the steam generators is conducted around the hydrogen and oxygen gas conduits to warm the gases for further confined expansion or increased pressure and flow velocity through the gas flow electric generators previously described. Finally the remaining heat is deposited into the chamber and fluids of the water electrolyzer to catalyze the process of cracking water into its elemental hydrogen and oxygen gases. The Resource Tower provides a design and structure to most efficiently use the greatest amount of energy produced from the process of hydrogen and oxygen production, with an environmentally neutral or potentially positive impact influence.

At a time where evolving and advanced societies have a demand for electricity and traditional electricity production options are limited, the Resource Tower provides needed solutions. The Resource Tower produces electricity from one or more elevated electricity generating fuel cells, a second source from one or more steam powered electrical generators, a third source from falling water through electricity generators, a fourth from electricity generation from the flow of a double volume of hydrogen gas, a fifth electricity generation contribution from the flow of oxygen gas, and ultimately purified and potable water is a sixth and often just as necessary resource in communities across the globe all extracted from the Resource Tower. The Resource Tower is deployable to any global location, scalable, requires minimal resources, is a non-emitting and environmentally friendly design, and is capable for also providing purified and potable water. The electricity and water of the Resource Tower are advancements for this time.

The present invention now is described more fully hereinafter with reference to the accompanying drawings, in which embodiments of the invention are shown. The exemplary embodiments that follow with more detailed description are not intended to limit the scope of the invention, as claimed, but is presented for purposes of illustration only to describe the features and characteristics of the present embodiments, to set forth the best mode of operation of the invention, and to sufficiently enable one skilled in the art to practice the invention. It should be understood by persons having ordinary skill in the art that the invention may be embodied in many different forms and should not be construed as limited to the embodiments set forth herein and various changes to the invention may be made without departing from the spirit and scope of the present invention. The specific embodiments are provided so that this disclosure will be thorough and complete and will fully convey the scope of the invention to those skilled in the art.

### Drawing Description

A description will now be made of the apparatus called a Resource Tower as an apparatus and its method of use.

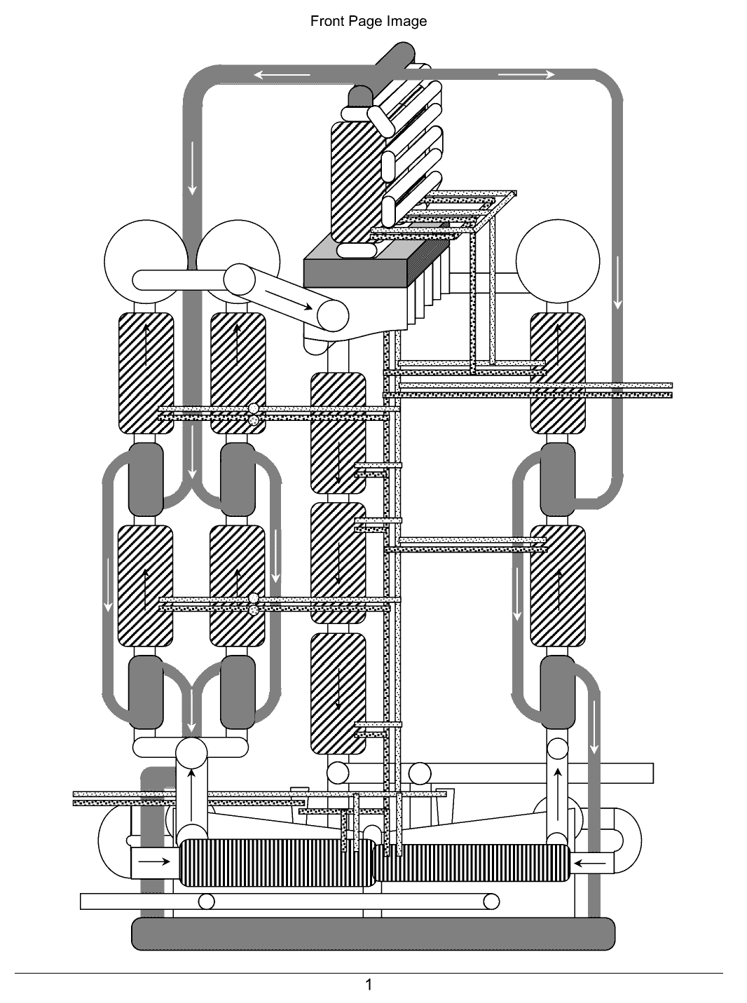

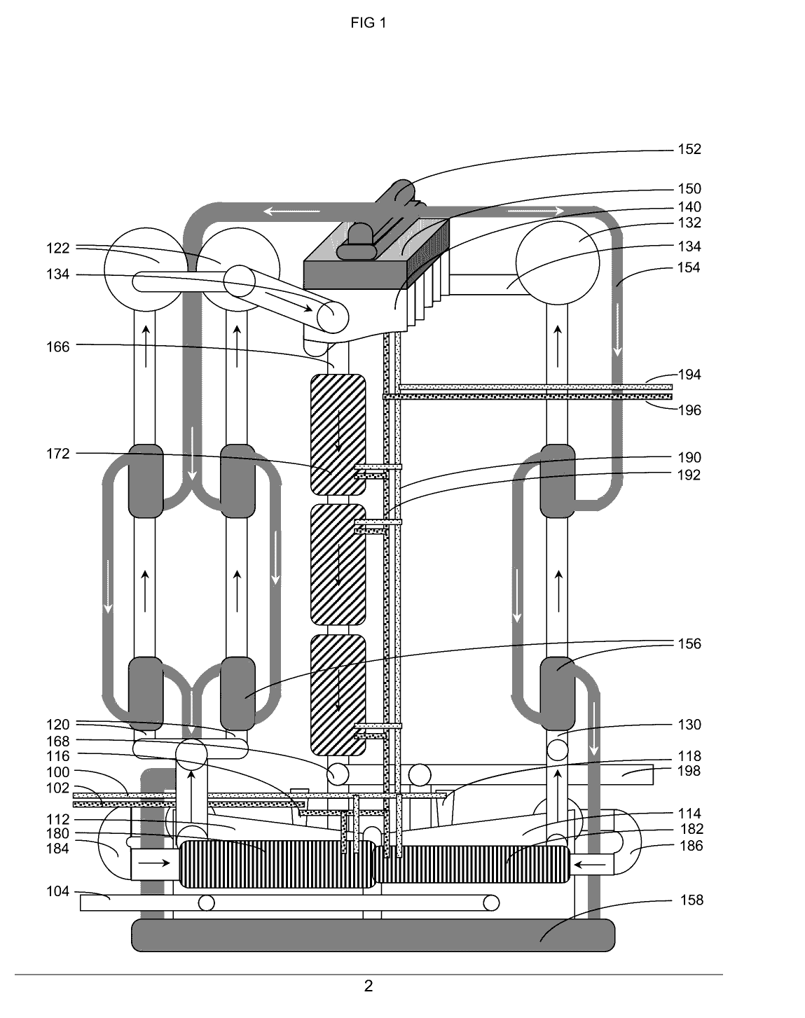

FIG. 1—The fundamental structure of the Resource Tower is illustrated to include an electricity producing fuel cell 140 elevated such that its water byproduct is also elevated and directed by water conduits 162 to flow downward through electricity generators 172 to create a net electricity or energy production above any energy consumption to create hydrogen gas and support tower operations. An additional benefit of the Resource Tower is the production of purified and potable water available under useful pressure, also due to the origination of the water flow from the top of the Resource Tower. Although mixed among other gases in air, oxygen is naturally plentiful, making hydrogen gas production the capacity limiting factor of the Resource Tower and the limitation of hydrogen gas. The Resource Tower is capable of utilizing hydrogen gas produced by any means whether integrated with the Resource Tower or as an external supply. It is a preferred mode of the disclosure that hydrogen gas production be integrated with the Resource Tower. A central purpose of the Resource Tower is to be deployed to villages and communities across the globe to provide meaningful supplemental and even alternative electricity production and potable water production to current traditional electricity and water production methods that are becoming less sustainable and less capable of meeting growing needs. It is preferred and even necessary that the Resource Tower have the capability to produce its own hydrogen gas. Of available resourced, water electrolysis is the current preferred choice. Innovation around water hydrolysis is not the thrust of the Resource Tower disclosure. The Resource Tower will utilize the most efficient and otherwise most appropriate water electrolysis components commercially available or even other forms of hydrogen production as they may surface as more efficient and otherwise suitable and draw upon skill in these arts for constant refinement of hydrogen production with the Resource Tower. The formation of hydrogen gas by any means is an energy consuming or penalizing process. The objective of the Resource Tower is to overcome the energy penalties of hydrogen gas production and provide sufficient net energy production to provide a viable supplemental or alternative electricity resource to communities across the globe. To initiate Resource Tower production, an energy stimulus is required to initiate H₂ hydrogen gas production by electrolysis of water, which device will be referred to as an electrolyzer 110. The electrolyzer 110 is illustrated as having a cathodic H₂ hydrogen producing chamber 112, membrane 110, and anodic O₂ oxygen producing chamber 114. Electricity stimulus by a positive pole charge 100 feeds to the cathode 116 from which H₂ hydrogen gas is produced and the electricity stimulus by a negative pole charge 102 feeds to the anode 118 from which O₂ oxygen gas is produced. Also needed initially and occasionally in a closed system, and initially and continuously in an open system is the supply of dirty and briny water through the water supply 104. Dirty and briny water contain charge carriers or electrolytes needed for proper water electrolysis. Any non-ideal electrolyte condition of water supply will be altered for maximum water electrolysis. The water supply 104 is a general representation of any water, electrolyte, or other supply or discharge for the most efficient water electrolysis and formation of hydrogen gas. Not shown throughout this or other drawings are the processors, code, and controls ascribed as 106 associated with accepting and controlling electrical stimulus input, water and reagent input, the system, electricity distribution output, and water distribution output. The positive 100 and negative 102 electrical energy sources are feed into the electrolyzer for in-situ H₂ hydrogen gas production. With production of hydrogen gas follows a hydrogen gas pressure from the continued decomposition of water into its elemental components. For each molecule of water disassociated there are two hydrogen atoms liberated to one oxygen atom released. As such the Resource Tower is constructed to account for the differential in gas pressure and volume between hydrogen gas and oxygen gas produced. Hydrogen gas is moved from the cathodic chamber of the electrolyzer through hydrogen conduits 120. The Resource Tower in this drawing elects to maintain common gas flow and pressure between hydrogen gas and oxygen gas by separating the double volume of hydrogen gas into two hydrogen conduits 120 equivalent to that of the oxygen conduit 130. Hydrogen gas and oxygen gas are illustrated as moving from their respective electrolyzer chambers into their respective conduits and upward to the top of the Resource Tower. The hydrogen gas is temporarily contained by the hydrogen buffer vessel 122 for pressure and flow rate metering 124. Oxygen similarly is transported to the top of the Resource Tower through the oxygen conduit 130 to its oxygen buffer vessel 132 and associated pressure and flow rate meter 134. Central to the advancements of the Resource Tower is the elevated hydrogen gas and oxygen gas to liquid water reactor. The conversion of dirty or briny water in the electrolyze 110 is associated with a high energy penalty. An offset to that energy penalty from the Electrolyzer 110 of the Resource Tower is the realization that gas flows nearly effortlessly in any direction to include upward at great heights for ultimate conversion to liquid water which delivers multiple energy benefits. The flow of hydrogen gas and oxygen gas occurs by a positive pressure created with continuous operation of the electrolyzer 110 that continuously produces double volumes of hydrogen gas and single volume of oxygen gas. To be described next is the consumption of hydrogen gas and oxygen gas creating a negative pressure that also draws the gas upward. There are a limited number of hydrogen gas and oxygen gas reactors for producing electricity and water as a byproduct to mount at the top of the Resource Tower. As a preferred mode, in this case a bank of fuel cells 140 is preferred due to their simplicity and efficiency. The Resource Tower is not focused on innovation associated with fuel cell construction, but chooses the most efficient design and components for the production of electricity, heat, and water. The Resource Tower will rely upon persons having ordinary skill in the art through commercial outlets to source the appropriate fuel cell. The choice of fuel cell may change based upon current efficiencies, use application, needed capacity, and other factors. As the hydrogen gas is metered 124 and oxygen gas is metered are consumed or metered 134 at required pressures, flow rates, and proportions the fuel cells 140 spontaneously produce electricity, heat, and water. The electricity is captured in the positive pole conductor 190 and negative pole conductor 192. The electrochemical reaction of H₂ hydrogen and O₂ oxygen is an exothermic or heat producing process. Given the strength of the hydrogen and oxygen molecular bond heat produced from this reaction is beyond trivial. Heat creates a thermal energy now available to assist in improving the performance and efficiency of the Resource Tower. Thermal energy or heat is captured by the fuel cell post-reaction thermal energy recovery or fuel cell heat sink 150 and transferred to the thermal energy manifold or heat manifold 152 for distribution to thermal energy conduit or heat conduits 154 and thermal energy transfer jackets or heat jackets 156. A simplification of the Resource Tower in the configuration illustrated in FIG. 1 could include the elimination of the heat conduits 154 and heat jackets 156 for direct transfer of heat to the Electrolyzer thermal energy catalyst 158, or even where deployment and use circumstances permit or dictate the heat recovery and distribution system as depicted by 150, 152, 154, 156, and 158 may be eliminated entirely for a simple atmospheric heat loss design. In the configuration illustrated, these heat conduits 154 and heat jackets 156 are positioned in one or more locations along the hydrogen conduits 120 and oxygen conduit 130 to raise the temperature of flowing gases to excite and expand the gases to maintain or increase transport pressure and flow rate. Ultimately, the heat is delivered to the electrolyzer thermal catalyst 156 where heat is absorbed by the cathodic chamber 112 and anodic chamber 114 to enhance electrolysis efficiency and reduced electrical consumption for hydrogen production. Water is a byproduct of the fuel cell bank 140 electrochemical reactions and develops in excess and naturally drains from an appropriately designed system into a water manifold for downward drainage by a water conduit 166. Under the inherent mass of water and acceleration by gravity the flow of water through the water conduit 166 creates a core source of additional energy and core innovation of the Resource Tower. That is the flow of water from a height has potential energy and the capacity for work. As water flows from the top of the Resource Tower downward it passes through one or more electricity generators 172. The electricity is placed into the electrical network positive pole 190 and electrical network negative pole 192. The height of the Resource Tower is variable and based upon component and use conditions. Contingent upon energy penalties or use with the Electrolyzer 110, the efficiency of electricity production by the fuel cell bank 140 and the water flow electricity generators 172 the height of the Resource Tower will be higher or lower to create needed a net electricity production for village and community distribution. The height will be determined by the amount of water flow electricity generators needed and space for water to maintain sufficient force to propel each electricity generator to overcome the electricity penalty of hydrogen gas production and electricity operating demands of the Resource Tower. At the bottom of the Resource Tower the water is diverted to water distribution valves 166 to create a closed system where the purified and potable water is recirculated back into the Resource Tower or opened and distributed for human and other uses at the potable water delivery port 198. Purified and potable water is a significant resource contribution of the Resource Tower for many villages and communities globally. The other significant resource created by the Resource Tower is electricity. Processors, code, and controllers manage electricity used as initial stimulus 100 and 102, electricity created by the Resource Tower 190 and 192, and ultimately the distribution of electricity with electricity positive pole 194 and electricity negative pole 196. The illustration of the Resource Tower just described forms the core advancements of this disclosure. Innovated is a system is the use of dirty water and through a process of phase changes of water from liquid to gas for effortless delivery of massive volumes of water to heights of the resource tower by hydrogen gas and oxygen gas, then recombining these gases to form electricity, heat, and liquid water. That liquid water has mass and under acceleration of gravity creates another electricity generating capacity. The Resource Tower becomes socially significant. Villages and communities across the globe will benefit from the electricity and potable water made available by a system that a Resource Tower at equilibrium as a net positive electricity and water producer by exploiting the forces of nature.

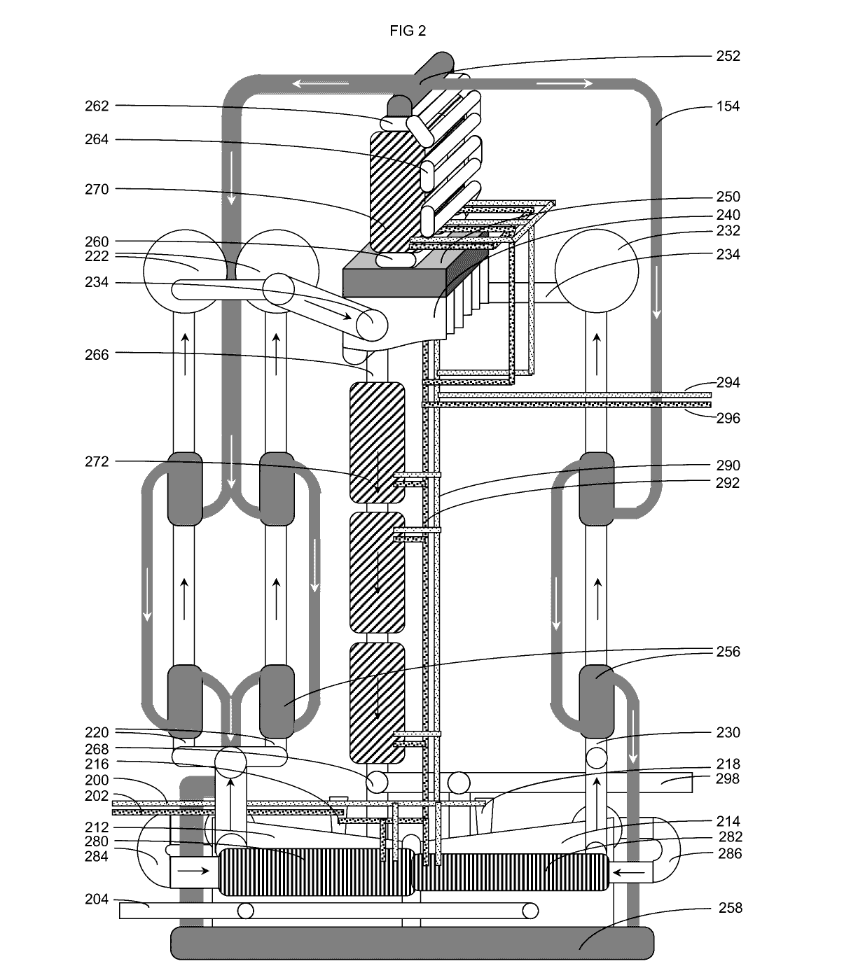

FIG. 2—The central concern of the Resource Tower is maximizing net electricity production. This drawing is an exact replica of FIG. 1 and contains the same description of the apparatus and operation of the apparatus, with one addition to increase electricity production. A key feature of a fuel cell is achieving efficiencies above and below or near 80% or well above other form of electricity production. This efficiency is not all in the form of electricity production, but is achieved when combined with accounting for useful purposes derived from the heat produced from the fuel cell. In simple forms as discussed above a home based fuel cell can be accounted as highly efficient when considering electricity production and hot water production for home heat or other purposes. This form of dual accounting of fuel cell products of electricity and heat is called coproduction. This diagram represents the additional utilization of heat produced from the fuel cell to add additional electricity production. Review of FIG. 1 description explains the apparatus and method of creating H₂ hydrogen gas and O₂ oxygen gas and their delivery to the fuel cell banks 240. Based upon the rate of hydrogen gas metering 224 and oxygen gas metering 234 to the fuel cell banks, there is a spontaneous production of electricity, heat, and water. The description of the extraction and use of electricity and water from the fuel cell has been discussed with FIG. 1 and applied to FIG. 2 with corresponding figure and component numbers (fuel cell banks in FIG. 1 being 1 (figure number)+40 (component number)=140 and in FIG. 2 being 2+40=240, and other like component translation between common figures). Remaining is a full utilization of heat as a byproduct of the hydrogen gas and oxygen gas exothermic electrochemical reaction. Here in FIG. 2 the description of the illustration includes the addition of electricity generation based upon the full extraction of heat from the fuel cell banks. Heat is fully extracted by the fuel cell bank post-reaction thermal energy recovery or fuel cell bank heat sink 250 for conversion to steam in the flash steam converter 260. Water flashed into steam is contained in a closed system that ultimately recaptures the steam after electricity generation in the steam collector 262 and condensing coil 264 for delivery to the flash steam converter 260 to complete a full water to steam to water repetitive cycle. The flash steam effect and water vapor expansion are used to drive steam powered electricity generators 270, or steam based electrical generation by any means of fuel cell bank heat capture and transfer to the closed water to steam to water system. As another system of electricity generation, the water byproduct of the hydrogen and oxygen fuel cell is again coalesce into water that flows and fall through the water conduit 266 as previously described for additional electricity generation. Also degraded but still present is thermal energy captured by the heat manifold 252 and distributed as described in FIG. 1. All other processes of FIG. 1 follow as previously described. The discussion of FIG. 1 with the additional steam powered electricity generation described in FIG. 2 contributes the benefit to the Resource Tower of provided net additional electricity delivery to the electrical network and availability at the electrical junction with electricity positive pole 294 and electricity negative pole 296 for external use. The increased electricity production creates a greater net Resource Tower electricity availability and the option to reduce the Resource Tower height based upon deployment conditions and use needs. The additional usage of water in the form of steam has no affect upon the purity and potable nature of the water arriving at the base of the Resource Tower potable water delivery port 298. This water is also still available for use when the Resource Tower is operated in an open system manner.

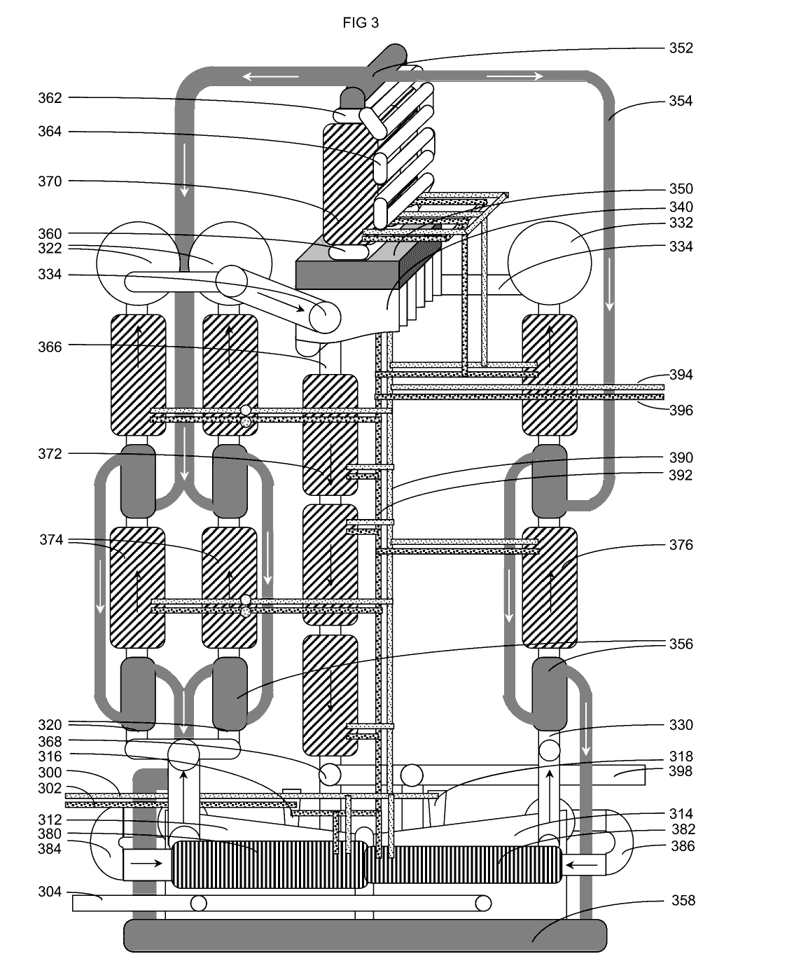

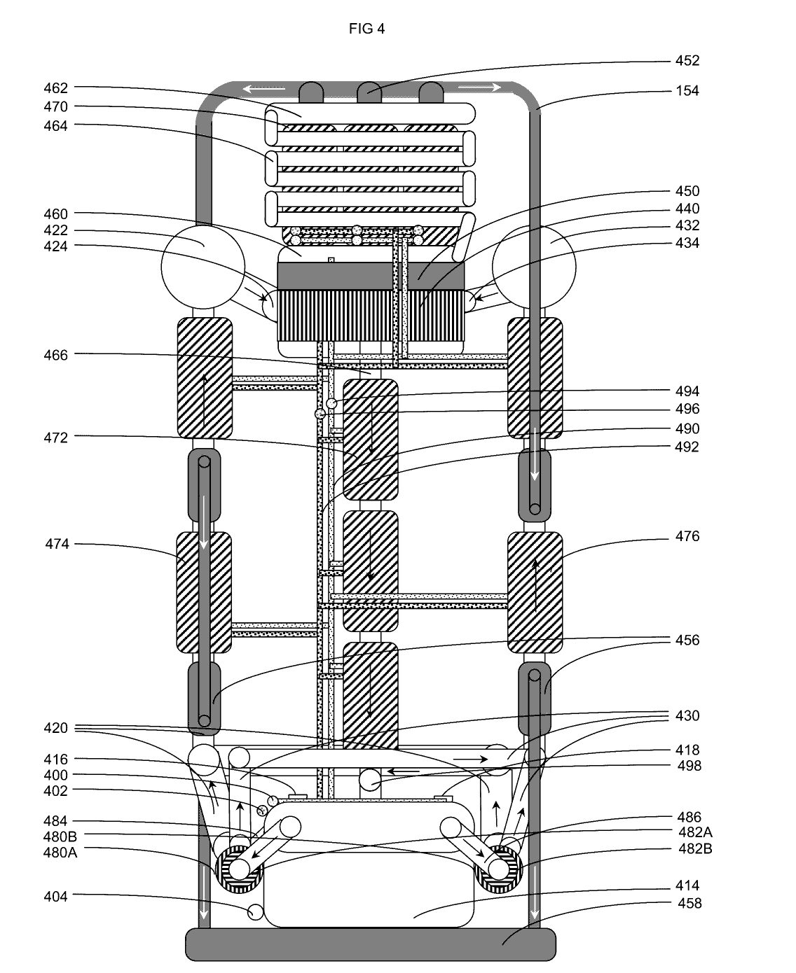

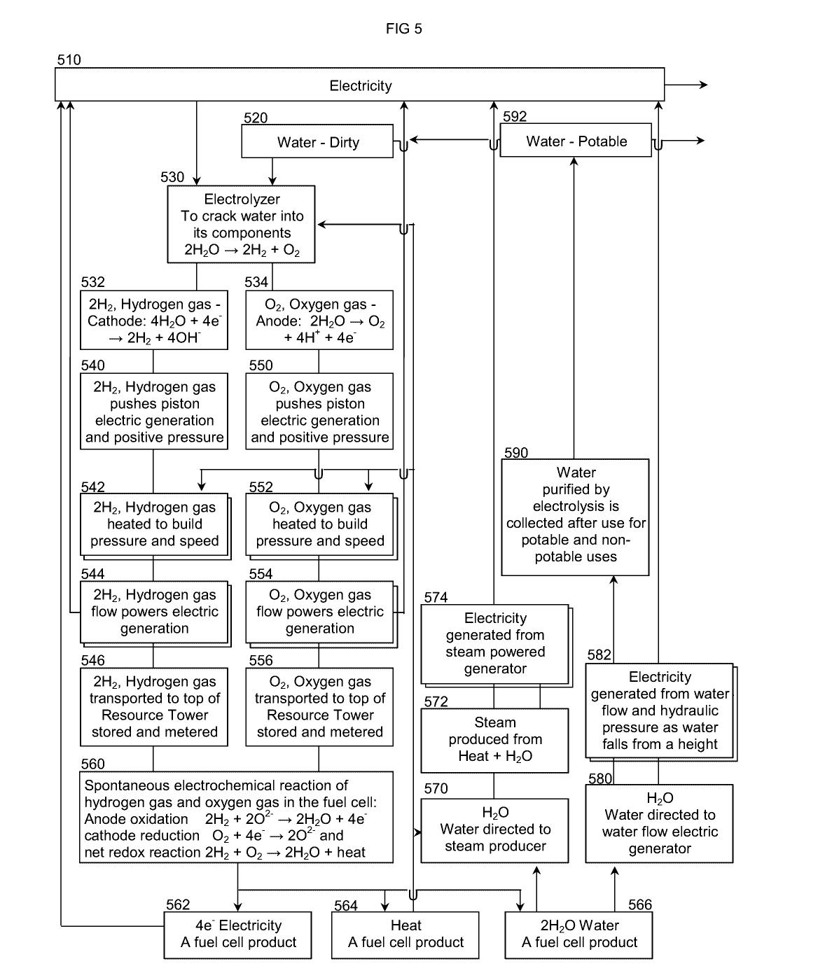

FIG. 3—The full embodiment of the Resource Tower is illustrated. Incorporated in this configuration are the apparatuses and methods illustrated in FIG. 1 and FIG. 2 and disclosed and expanded upon in their respective descriptions. Rather than repeating equivalent processes previously described, a focus is placed upon the additional advances and innovations of the Resource Tower illustrated in FIG. 3, being the addition of significant electricity production from gas flow electricity generators. FIG. 1 and FIG. 2 both included two hydrogen conduits depicted in FIG. 3 as hydrogen conduits 320 that could have easily been combined. Although not chosen, the option remains to combine these hydrogen conduits into one conduit of appropriate size to accommodate the double volume of hydrogen gas produced for a single volume of oxygen gas produced from the electrolyzer. The purpose of the dual hydrogen conduits is the decision to choose a uniform sized gas flow electricity generator. The Resource Tower is designed to accept one or more oxygen gas flow electricity generators 376, with two per conduit shown here, mounted in the oxygen gas flow conduit 330 or as a diversion of flow to a generator (not show). The Resource Tower is designed to accept one or more hydrogen gas flow electricity generators 374, with two per conduit shown here, and mounted in the hydrogen gas flow conduit 320 path or as a diversion of flow to a generator (not shown). Again, a different and acceptable choice is to design a single hydrogen gas conduit of larger size and then to specify hydrogen gas flow electricity generators to accommodate and to capitalize upon the greater volume flow. Also illustrated is the connection of each gas flow electricity generator to the internal electrical distribution network for availability at the electrical junction with electricity positive pole 394 and electricity, negative pole 396 for external use. FIG. 3 further illustrates the benefit of capturing fuel cell bank 340 heat in a manifold and delivery to heat conduits 354 and heat jackets 356 as previously described. In this configuration, the adding thermal energy to the hydrogen gas and oxygen gas while traveling up their respective conduits occurs prior to the gas flow electricity generators. The thermal energy adds excitation to the movement of the gas molecules resulting in added pressure and flow force to maintain effective gas flow electricity generation across each of one or more gas flow electricity generators of the hydrogen conduits 320 and oxygen conduits 330. An additional contribution to electricity generation as well as a type of positive displacement pump for gases distant from the pressure source is the hydrogen electricity reciprocal generator 380 and the oxygen reciprocal generator 382 also referred to as the hydrogen-oxygen conjoined reciprocating electricity generator. The incorporation of additional gas flow or water flow electricity generators fits within the definition of one or more electricity generators. The incorporation of the hydrogen-oxygen conjoined reciprocal electricity generator is a display of the flexibility to incorporate various means of electricity generation. This same position could be installed with electricity generators like those used elsewhere in the Resource Tower. The specific type of electricity generator is not the focus of this disclosure and the most efficient and acceptable electricity generator commercially available will be utilized by the Resource Tower based upon deployment and use conditions to list two of many considerations. The reciprocal electricity generator is a particular disclosure and claim in this application and will be further discussed. In this FIG. 3 configuration the hydrogen gas conduit is initially turned from the cathodic H₂ hydrogen producing chamber 312 with hydrogen reciprocal conduit 384. The hydrogen gas near the electrolyzer is under the greatest pressure and capable of the most work. Not shown in FIG. 3, but shown in FIG. 4 is the presence of two hydrogen-oxygen conjoined reciprocal electricity generators. This facilitates the hydrogen gas under pressure, controlled by valves shown in FIG. 4, to open and close in a reciprocating and synchronized manner between inlet and outlet valve ports between the two hydrogen reciprocating electricity generators 380 on opposite sides of the Electrolyzer and two oxygen reciprocating electricity generators 382 that similarly reciprocate in synchronized concert. Further the two hydrogen reciprocating electricity generators and two oxygen reciprocating electricity generators all work in a synchronized manner to maintain a constant hydrogen gas and oxygen gas flow. Beyond the additional electricity generation by four additional generators there is the simultaneous benefit of producing a mechanical-like positive displacement pressure on the hydrogen gas conduit 320 and the oxygen gas conduit 330 by reciprocating pistons described more fully in FIG. 5. The Resource Tower is a versatile and robust system capable recognizing and capitalizing upon multiple natural forces within it. The primary objective of the Resource Tower is to access a H₂ hydrogen fuel source. For deployability to villages and communities across the globe the in-situ generation of H₂ hydrogen and a readily available pure O₂ Oxygen oxidizer is ideally provided by water electrolysis. The energy penalty of electrolysis is overcome by energy penalty savings with the facile flow of hydrogen gas and oxygen gas to any height of the Resource Tower and multiple forms of electricity generation from near gas source in this configuration with a quadruple hydrogen-oxygen conjoined reciprocal electricity generators, multiple hydrogen gas flow electricity generators, multiple oxygen gas flow generators, fuel cell bank electricity generators, multiple steam powered generators, and multiple water drop electricity generators all connected to the internal electrical network within the Resource Tower for distribution to the community in which it resides. An important feature of the Resource Tower is that at equilibrium in operations, part or nearly all of the electrical demands to operate the electrolyzer, processors, code, and controls of the Resource Tower may be supplied by the Resource Tower itself. Given that there is no emission from the Resource Tower, being very environmentally neutral or even potentially positive impact, and at equilibrium very light on external power and resource demands, among other advantages, the Resource Tower is an ideal supplement and alternative to traditional electricity production in underdeveloped and advanced communities. As previously stated, the Resource Tower further is capable of purifying and supplying potable water to the same community to which is supplies electricity.

FIG. 4 is a right side view of the Resource Tower to provide an alternative and clarifying perspective. For understanding a full review of the Resource Tower from this perspective will be provided, but in abbreviated form. In a type of method explanation, the Resource Tower can be deployed to a village or community and configured based upon deployment conditions, use demands, and other factors. Once the amount of electrical energy is determined to be needed the Resource Tower height can be determined, within limits of resources or other circumstances. The Resource Tower is secure in place by ordinary construction methods or adjacent or in another man-made or natural structure. The Resource Tower is prepared for operation by filling the Electrolyzer with local water through the water supply 404 into the anodic electrolysis chamber 414 and the cathodic electrolysis chamber (opposite side and not shown). It is expected that the water contains salts and impurities that provide sufficient conductivity to facilitate charge carrying capacity in the water to permit electrolysis of water. In any case the sufficiency of electrolyte condition will be tested and supplemented as needed. An electric supply will charge the electrolyzer with positive pole electric supply 400 to the cathode and negative pole electric supply 402 to the anode. Immediately upon power supply to the Electrolyzer, H₂ hydrogen gas and O₂ oxygen gas begin to flow. The hydrogen gas first moves into the hydrogen reciprocal electricity generator supply conduit 484 (left backside of illustration) and into the hydrogen reciprocating electricity generator 480A (left back, the vertical lines behind the oxygen reciprocating electricity generator of horizontal lines). As the hydrogen reciprocating electricity generator 480A is filled, oxygen gas in the same associated oxygen reciprocating electricity generator 482A (left front) is expelled under the same pressure and flow rate. On the opposite, or right side of the Electrolyzer 414, the hydrogen-oxygen conjoined reciprocating electricity generator functions in an opposite manner. The oxygen from the Electrolyzer is first directed into the oxygen reciprocating electricity generator 482B (right front) and as it fills expels hydrogen gas from the hydrogen reciprocating electricity generator 480B (right back) with the same pressure and flow rate as oxygen entering the system. By processor, code, and controls synchronized valves create an orchestrated but opposite reciprocating motion between the two hydrogen-oxygen conjoined reciprocating electricity generators or four chambers, on opposite sides of the Electrolyzer. The positioning of the hydrogen-oxygen conjoined reciprocating electricity generators is arbitrary and is chosen for opposite side of the electrolyzer in this illustration. This synchronized, opposite, and reciprocating motion creates the first generation of electricity and provided to positive electric pole 494 and negative electric pole 496 of the internal electric network and presented to the community or sent back to offset external electric supply. As the hydrogen gas is positively displaced from the hydrogen-oxygen conjoined reciprocating electricity generators, it moves up the hydrogen conduit 420 and past the first heat jacket 454. As the Resource Tower has not reach equilibrium there is no heat to excite and further pressurize the hydrogen gas in the hydrogen gas conduit, but in time as thermal equilibrium occurs, there will be an increased efficiency. The hydrogen gas moving under new electrolysis of H₂ hydrogen, positive pressure displacement by the reciprocating electricity generator, negative pressure by gas consumption at the top of the Resource Tower, and the natural tendency of warm or heated gas to continue to expand, the hydrogen gas flows past the first gas flow electric generator 474 and creates a second continuous electricity generating event. The hydrogen gas continues to rise again passing a heat jacket 454. Under steady state conditions the hydrogen would be further energized and flows past a second gas flow electric generator 474 and repeating passage through heat conduits 454 and heat jackets 456 and gas flow generators for as many as are incorporated in a particular Resource Tower deployed design. Ultimately the hydrogen fills the hydrogen buffer vessel 422 and pressure and flow rate meter 424. Unique about the Resource Tower design is the duplication of hydrogen conduit path (not shown in this configuration) to accommodate the double volume of hydrogen gas to that of a single volume of oxygen gas. It creates an additional source of electricity production. In discussing oxygen gas, it follows the same path and behavior as hydrogen gas just discussed. The oxygen gas is released by water electrolysis and moves down the first oxygen reciprocating electricity generating conduit 486 and into the oxygen reciprocating electricity generator 482. Under positive pressure displacement, backpressure from newly formed oxygen gas, from negative pressure from oxygen gas consumption, and the natural tendency of a warm and hot gas to expand it moves up the oxygen conduit 430 and past the first heat jacket 454 and is accelerated under steady state conditions, past the first oxygen gas flow electricity generator 476. With continued flow the oxygen passes a second heat jacket 454, then another oxygen gas flow electricity generator 476, and this pattern or a pattern without the heat jacket or other pattern continues based upon the configuration of the Resource Tower until the oxygen reaches the oxygen buffer vessel 432 and oxygen pressure and flow rate meter 434. At this stage in the Resource Tower cycle there has been multiple electricity generation opportunities and hydrogen gas and oxygen gas remain with their chemical potential for additional electricity, heat, and water production. The flow of hydrogen gas and oxygen gas will eventually stop without a release or consumption of the gases. At this stage in the cycle of liquid water to gas extraction of energy production, the hydrogen gas at a double volume to oxygen gas are metered into the fuel cell bank 440. Spontaneously upon exposure of hydrogen gas and oxygen gas to the fuel cell bank there is the production of electricity and delivery into the internal electrical network through positive pole conductor 490 and negative pole conductor 492. Heat generated by the fuel cell bank is capture by the heat sink 450 and used by the flash steam converter 460 for further steam powered electricity generation 470. The steam degrades quickly releasing its heat which is collected by the heat manifold 452 and distributed to improve pressure, flow, and efficiency of the gas flow and gas generation system through the heat conduits 454 and heat jackets 456 and ultimately to the Electrolyzer thermal energy catalyst 458. The controlled structure of the Resource Tower readily facilitates the addition of electricity production, but the facile transport of hydrogen gas and oxygen gas to the top of the Resource Tower and conversion to liquid water by a reactor or fuel cell at a height. This water now at a height has potential energy that upon downward fall powers electrical production and is a significant inventive leap for energy production and a needed resource for villages and communities around the globe. This last process of energy contribution and production occurs by the collection of byproduct water from the hydrogen and oxygen fuel cell into the water conduit 466. The collected water becomes an accelerating mass under gravity through the water conduit 466 passing through a first, second, and third water flow electricity generators 472 as illustrated in this configuration. The number of water flow electric generators depends upon the height of the Resource Tower and maintaining the momentum of water flow through sequential water flow electric generators. Ultimately the water is directed by water distribution valves to reenter the Electrolyzer chambers in a closed system configuration or directed as a resource out of the Resource Tower as purified and potable water. Significant with the description above is the numerous and naturally occurring electric generation sites on the Resource Tower to return electricity and overcome the energy penalty of the Electrolyzer 414 as a net increase in electricity is available to distribute among villages and community surrounding it place of deployment. Considering the many water borne diseases across less developed parts of the world, the availability of purified and potable water is an additional significant contribution of the Resource Tower.

FIG. 5 is a flow diagram for the method of electricity generation and purifying water by the preferred embodiment of the Resource Tower. That best mode is the utilization of the maximum number of driving forces for electricity generation and the maximum number of electricity generator to produce the greatest electricity distribution to villages and communities of its deployments. Each embodiment of the Resource Tower provides purified and potable water which is an additional and valued resource, if the Resource Tower is not operated as a closed system. An apparatus perspective of how the Resource Tower operates is discussed in FIG. 4 in some detail. The discussion here will focus on the processes and steps rather than the function of the apparatus. The Resource Tower is initially fully dependent upon an external electricity 510 source to provide the driving force for water electrolysis at the electrolyzer 530. The electrolyzer creates an energy penalty over which the Resource Tower must produce that threshold amount of electricity before it can return a net contribution of electricity externally to the village or community. Also needed is a source of water 520. It is expected that the water sourced will be dirty water from surface, well, or sea sources. This dirty water often contains sufficient contaminants to satisfy the electrolyte requirements of the electrolyzer, or the appropriate electrolyte balance will be otherwise established. A continuous input of water will be required with the Resource Tower operated in the open mode or where the purified water will be distributed to villages and communities. When operated as a closed system and at equilibrium the amount of water required by the Resource Tower may be minimal as the water returning from atop the Resource Tower will flow back to the electrolyzer. With a properly prepared electrolyzer upon the application electricity hydrogen gas 532 is produced at the cathode and oxygen gas 534 is produced at the anode. In the preferred embodiment of the Resource Tower there is the presence of the hydrogen-oxygen conjoined reciprocal electricity generator into which flows hydrogen gas 542 to push the strong magnetic piston past the conductive coils of the reciprocating generator and oxygen gas 550 flows into the opposite hydrogen-oxygen conjoined reciprocal electricity generator. Through synchronized oscillation by processors, code, and controls the result if the first generation of electricity and the benefit of a positive pressure pump. Upon departure of hydrogen gas enters its double conduit and under steady state conditions are heated 542 by each conduit's heat conduits and heat jackets. Oxygen gas also enters its conduits and under steady stated conditions are heated 552 by heat conduits and heat jackets. This added thermal energy excites the gas and imparts added pressure and flow rate to drive hydrogen gas flow electricity generators 544. Oxygen similarly is excited with increased pressure and flow rate to power the oxygen gas flow electricity generators 554. Depending upon deployment circumstances of the Resource Tower hydrogen gas may pass one or more additional heat conduits and heat jackets 542 and electricity generators 544. Oxygen processes would mimic those of hydrogen gas and would then pass through one or more additional heat jacket 552 and oxygen gas flow electricity generator 554. Ultimately hydrogen gas is transported to the top of the Resource Tower stored and prepared for metering 546 into the fuel cell. Similarly oxygen gas is transported to the top of the Resource Tower and its storage vessel and prepared for metering 556 into the fuel cell. A key attribute of the Resource Tower is the ability to transport large volumes of water in elemental form to heights of the Resource Tower essentially in a facile manner and without great energy penalty. As hydrogen gas and oxygen gas are metered into the fuel cell at appropriate proportions and rates there is a spontaneous electrochemical reaction 560 that occurs in the fuel-cell resulting in the production of electricity 562, heat 564, and water 566. The advancement of the Resource Tower is the positioning of the electrochemical reactor, in this case the fuel cells at a height, resulting in water form at that same height. The Resource Tower has already extracted electricity from the flow of gases and now produces additional electricity 562 through the fuel cell and with additional electricity capacity still remaining. Heat 564 is a significant byproduct of the fuel cell as is water 566. Combining these other byproducts, additional electricity is generated as the thermal energy 564 is injecting across high surface area separated water 570 to create a near instantaneous steam 572 resulting in a rapid expansion of water vapor which is directed to steam powered electricity generators 574. Like other forms of electricity production, this resource is directed to the internal electricity network 510 connected to the original source electricity 510 with polarity, alternating frequency, and other requirements facilitated by processors, code, controls. Ultimately a core purpose of positioning the electrochemical reactors, or fuel cells, at a height is to draw upon the characteristics of the byproduct of water or its mass and acceleration under gravity to also produce electricity. A well-designed fuel-cell structure naturally extracts water which is then directed in a downward flow 580. By the mass of water and acceleration under gravity there hydraulic pressure and water flow electricity generation produces electricity 582. An important consideration in the height of the Resource Tower is the efficiency of the gas or water flow electricity generators to produce electricity to meet Resource Tower requirements. The more electricity is needed the higher the tower, the more gas flow and water conduits for electricity generation, or the deployment of additional Resource Towers. An enabling condition of the Resource Tower is the ability to readily distribute hydrogen gas and oxygen gas to accommodate any configuration of the Resource Tower and deployment needs. A unique characteristic of breaking water into its elemental hydrogen and oxygen is their facile distribution throughout the Resource Tower. The process of water electrolysis creates purified hydrogen and oxygen gas and the fuel cell also produces a purified state which together provide for a purified water 590 which then flow back to the electrolyzer 530 or be distributed as potable water 592 for human consumption and other purposes. Water dropping from a tower will also have a useful water pressure. FIG. 3 shows a method of taking initial electricity input and water resources and using these initial resources to produce five additional sources of electricity of different magnitudes based upon the number of generators in each respective location as well as the production of purified and potable water. The resource Tower becomes a supplement and even an alternative energy source for villages and communities of underdeveloped and developed villages and communities across the globe.

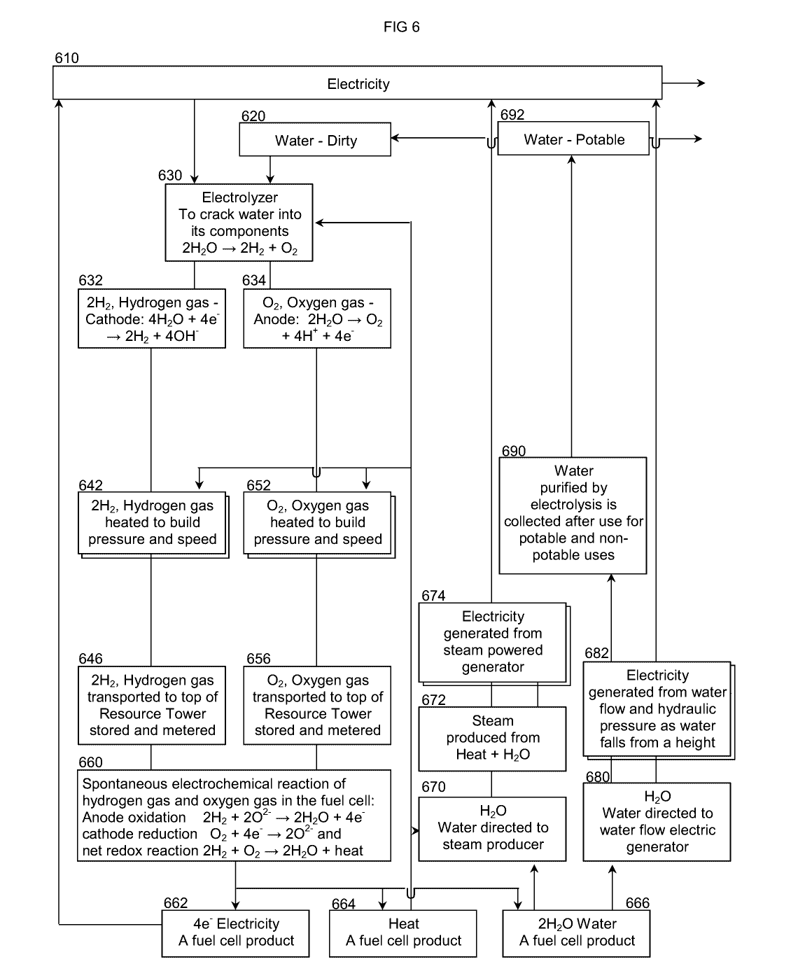

FIG. 6 is a replica of the method flow diagram of FIG. 5 but with the removal of gas flow electric generation. Now having an understanding of the Resource Tower from both an apparatus and method perspective, it is evident that the removal of the gas flow electric generators is also an acceptable configuration. The Resource Tower is a flexible structure designed to accommodate the electricity and potable water needs of a village or community. The specific configuration of the Resource Tower is can vary. What is not variable is the advancement of an elevated electrochemical reactor, such as a fuel cell that converts hydrogen gas and oxygen gas into electricity and simultaneously results in the formation of water at a height. With this basic structure in place, FIG. 6 shows an acceptable alternative to the preferred embodiment with methods of operation as previously described, but without the steps associated with any absent components. The method without these absent components is seamless as hydrogen gas and oxygen gas continue to be produced and flow, and their combination continues to produce heat and water that produces additional steam powered electricity and then water that falls for electricity generation and potable water supply.

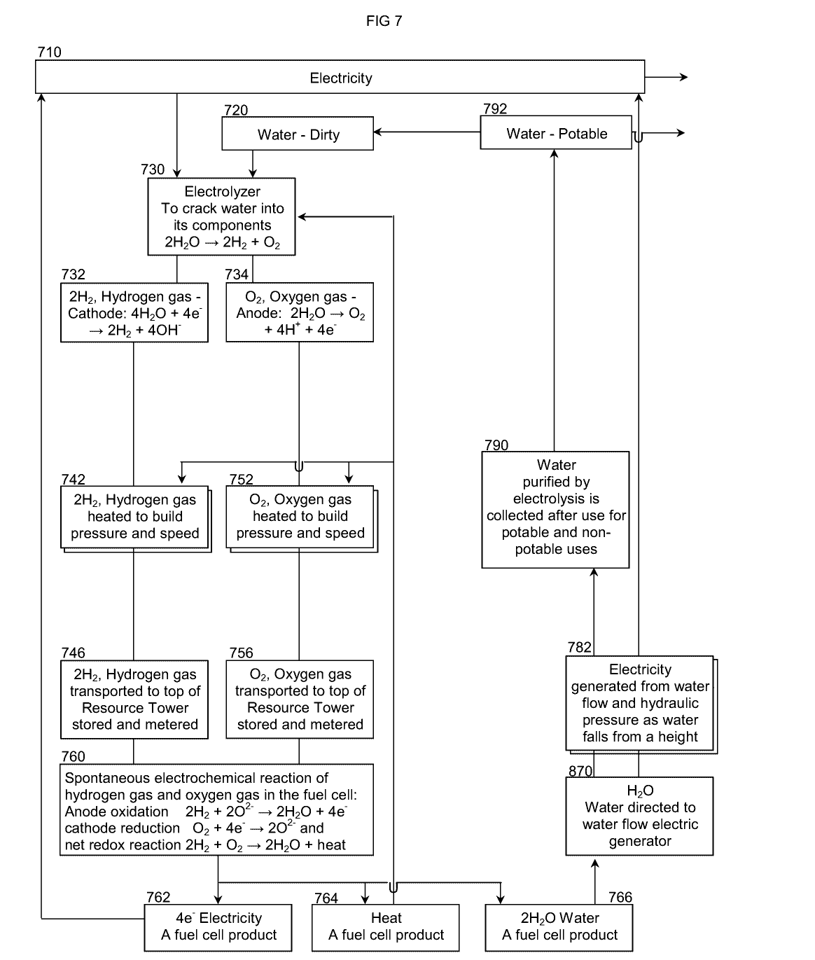

FIG. 7 is a method flow diagram that replicated that of FIG. 5 but with the removal of hydrogen gas and oxygen gas flow generation as well as steam powered electricity generation. As previously stated, this configuration is a simplified Resource Tower method that highlights the core elements of the advancements disclosed. A description of the method of FIG. 7 is embedded in the detailed description of FIG. 5. It is evident and seamless that the elimination of the hydrogen gas and oxygen gas flow electricity generation as well as steam powered electricity generation do not interfere with the core operation and advancements of the Resource Tower. The method of FIG. 7 provides an acceptable simplified core innovation method for the Resource Tower and may be the preferred embodiment for various village and community deployments.

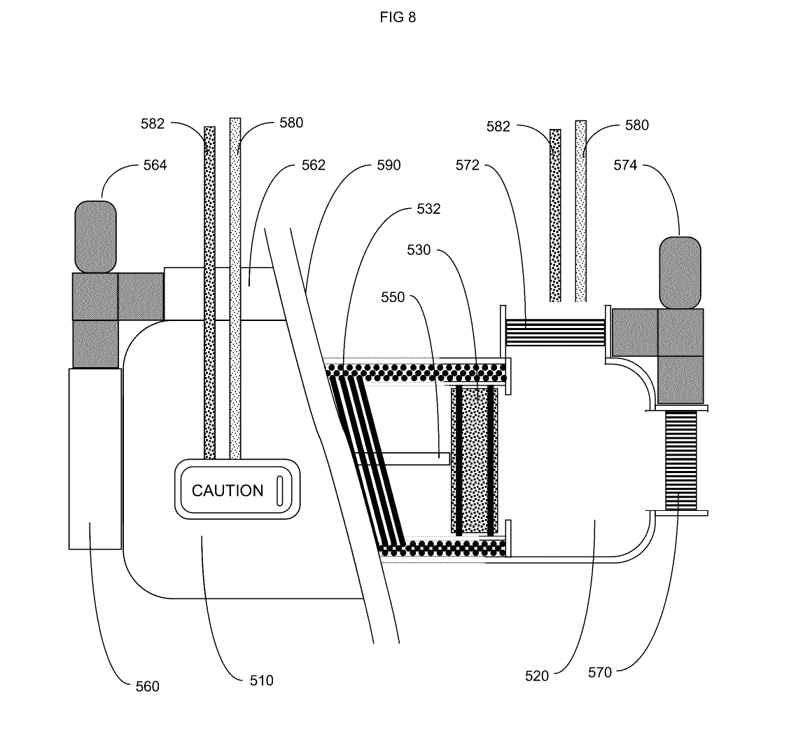

FIG. 8 is an open perspective of the hydrogen-oxygen conjoined reciprocating electricity generator. H₂ hydrogen and O₂ oxygen gas pressure is highest coming from the Electrolyzer as there is little opportunity for expansion and is in the most manageable condition to harvest that pressure for increased efficiencies and control throughout the Resource Tower. The hydrogen-oxygen conjoined reciprocating electricity generator with its further positive displacement pumping affect provides for electricity generation at this favorable post Electrolyzer position and ensures hydrogen gas and oxygen gas movement and elevation to any Resource Tower height. Like other secondary systems of the Resource Tower, the hydrogen-oxygen conjoined reciprocating electricity generator is shown to be absent in FIG. 1 and FIG. 2, but present as an enhancement in FIG. 3 with hydrogen reciprocating electricity generator 380 integrated mechanically or conjoined with an oxygen reciprocating electricity generator 382. Also in FIG. 8 the hydrogen reciprocating electricity generator 480 is shown behind the oxygen reciprocating electricity generator 482. An important observation of the hydrogen-oxygen conjoined reciprocating electricity generator is that the chamber of the hydrogen reciprocating electricity generator 810 is larger than the oxygen reciprocating electricity generator 820 and in this illustration the length of the device is abbreviated by the cutaway indicator 890. This necessity is born from the water molecule containing two hydrogen atoms for every oxygen atom. As known and previously discussed water electrolysis therefore produces a double volume of hydrogen for a single volume of oxygen. A larger hydrogen chamber accounts for an equivalent motion and stroke within the conjoined reciprocating electricity generator given difference in hydrogen gas and oxygen gas volumes. This accommodation also ensures an equal pressure and flow of hydrogen gas and oxygen gas through the Resource Tower despite their difference in gas volume. In essence the hydrogen-oxygen conjoined reciprocating electricity generator is the combination of two reciprocating electricity generators sized to facilitate equivalent mechanical motion, stroke, and resulting pressure of two dissimilar gases and volumes. As with other induction based electricity generators this system includes a strong magnetic moving in the presence of a conductive coil. In the illustration of the hydrogen-oxygen conjoined reciprocating electricity generator, the hydrogen reciprocating electricity generator 810 is illustrated as a closed perspective and the oxygen reciprocating electricity generator 820 is illustrated as an open perspective. Illustrated in the open perspective of the oxygen reciprocating electricity generator 820 is the smaller oxygen chamber strong magnetic piston 830 and associated oxygen chamber conductive coils 832. The larger diameter hydrogen reciprocating electricity generator 810 chamber strong magnetic piston and the associated conductive coils exist, but are not illustrated due to the closed perspective. An important feature of the variable size of the system is the mechanical connection of the oxygen chamber strong magnetic piston 830 to the hydrogen strong magnetic piston (not shown) by a magnetic piston push rod 850 to maintain piston relationship and positively transfer pressure from one chamber to the next. A cycle of motion starts based upon the rest position of the magnetic piston push rod 850 or other movable component (piston, valves, etc.). In the FIG. 4 description there is an example of the synchronized, yet opposing motion of the two hydrogen-oxygen conjoined reciprocating electricity generators positioned on the left and right side of the Electrolyzer. From an internal perspective of the hydrogen-oxygen conjoined reciprocal electricity generator the following example is illustrative of its operation. Hydrogen gas is feed into the hydrogen reciprocating electricity generator through the hydrogen inlet connection valve 860, a closed hydrogen outlet connection valve 862, and hydrogen valve control 864 operated by appropriate processors, code, and other controls. The hydrogen gas enters and pushes the hydrogen chamber strong magnetic piston into the hydrogen reciprocating electricity generator and generates electricity. The magnetic push rod 850 transfers that action under hydrogen pressure onto the oxygen strong magnetic piston 830 and with this motion also generates electricity as it travels past the conductive coils 832 of the oxygen reciprocating electricity generator 520. As the oxygen strong magnetic piston 830 travels oxygen gas is pushed under pressure through the oxygen outlet connection valve 872, with closed oxygen inlet connection valve 870, and produces positive pressure of oxygen gas throughout the remainder of the Resource Tower oxygen conduits. At the end of this stroke, the oxygen outlet connective valve 872 is closed and the oxygen inlet connective valve 870 is opened by the oxygen valve control 874 in concert with appropriate processors, code, and other controls. Simultaneously, the hydrogen inlet connective valve 860 is closed and the hydrogen outlet connective valve 862 is opened by the hydrogen valve control 864. This synchronization within this hydrogen-oxygen conjoined reciprocating electricity generator is also oppositely synchronized with one or more other hydrogen-oxygen conjoined reciprocating electricity generators by use of processors, codes, and other controls not specifically detailed, but readily available within known art. The result of the movement of the hydrogen strong magnetic piston and the oxygen strong magnetic piston 850 through conductive coils 832 is the generation of electricity delivered to the internal electrical network through positive pole conductors 880 and negative pole conductors 882. Associated processors, code, and controls are used to convert the direct and cyclically reversing current into standard alternating current. These processors, code, and control are again not the inventive focus of the Resource Tower but will draw upon known market skills and components. The hydrogen-oxygen conjoined reciprocal electricity generator is one of various electricity generators available to incorporation with the Resource Tower. The configuration of the Resource Tower in FIG. 3 and FIG. 4 preferentially use the hydrogen-oxygen conjoined reciprocal electricity generator for capturing maximum hydrogen gas and oxygen gas pressure near the Electrolyzer for positive pressure affect throughout the gas conduit structure of the Resource Tower while simultaneously contributing to electricity generation.

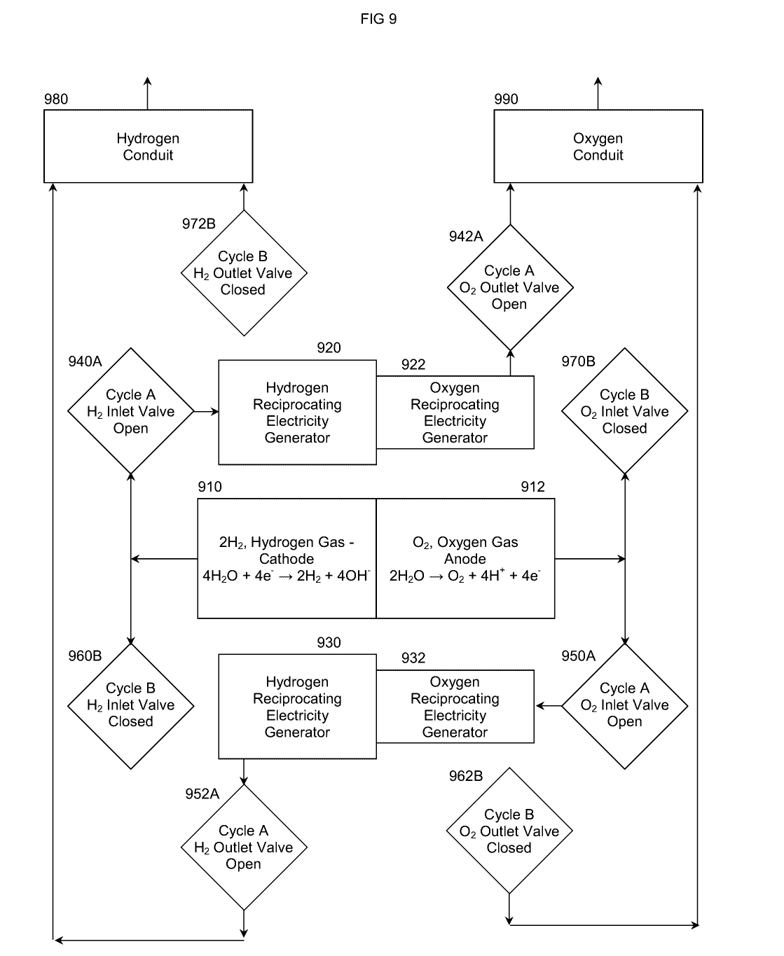

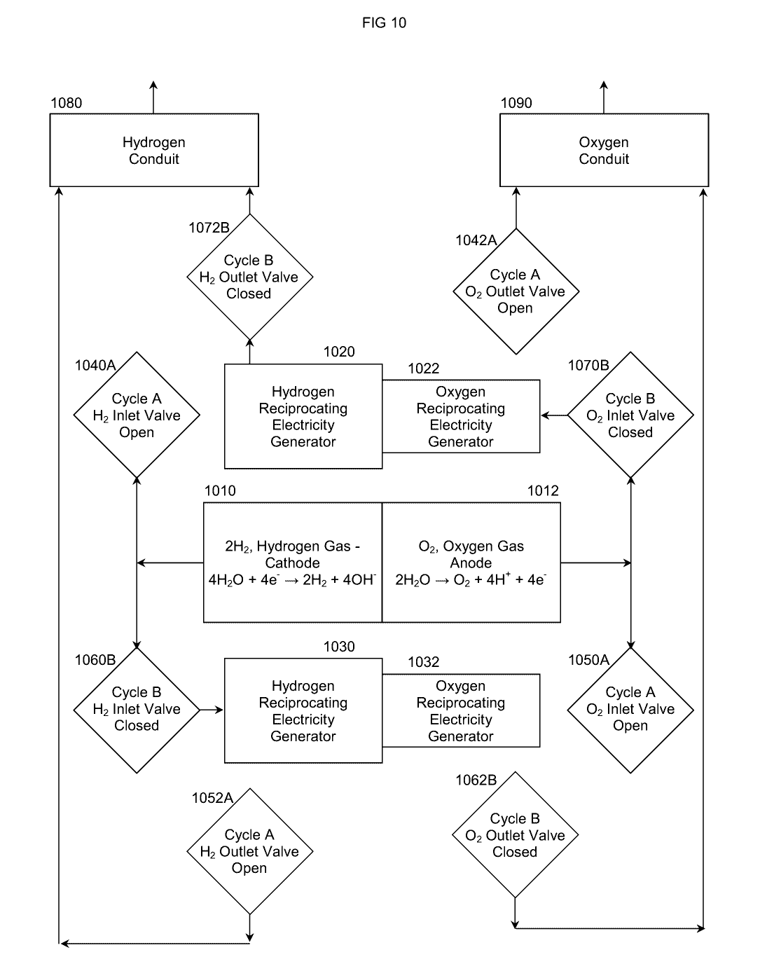

FIG. 9 is a flow diagram of the hydrogen-oxygen conjoined reciprocal electricity generator with positive pressure pumping. This figure is representative of one half reciprocal oscillation cycle with FIG. 10 representing the second phase of the reciprocal oscillation cycle. The purpose of the hydrogen-oxygen conjoined reciprocal electricity generator is opportunity to capitalize upon the largest hydrogen gas and oxygen gas pressure near the source of the water electrolysis electrolyzer to do unique work. As the hydrogen gas and oxygen gas have thus far been confined to limited cavities there is a more controlled pressure environment. That higher and more controlled pressure is available for electricity production and such a reciprocal piston type outward stroke provides a positive pressure affect upon the remaining Resource Tower hydrogen gas and oxygen gas conduits, vessels, meters, gas flow electricity generators, and other gas environments. A first stroke or at equilibrium with the presence of water in an electrolyte and the application of appropriate voltage and current, 2,687 liters of hydrogen gas from the cathode 910 and 1,344 liters of oxygen gas from the anode 912 for every liter of water. Such an expansive release of gas in a confined conduit creates pressure delivered into associated conduits and valves. Under this first half of the hydrogen-oxygen conjoined reciprocal electricity generation oscillation, cycle A hydrogen inlet valve 940A is open allowing hydrogen gas flowing under pressure from the cathode 910 into the hydrogen reciprocating electricity generator 920. This pressurized hydrogen gas movement moves the strong magnetic piston inward past the conductive coils for the production of electricity and distribution into the Resource Tower internal electricity network. This movement is possible as cycle A oxygen outlet valve 942A is open allowing oxygen gas from the conjoined oxygen reciprocating electricity generator 922 to exhaust its oxygen gas from a previous oscillation. As the hydrogen strong magnet piston is pushed inward the connected oxygen strong magnetic piston is pushed outward past its conductive coils for electricity production. The electricity generated is delivered into the Resource Tower internal electricity network for use or distribution. The oxygen gas is pushed under positive displacement pressure in front of the oxygen reciprocal electricity generator's strong magnetic piston. The oxygen is distributed into the oxygen conduit 990 and throughout the Resource Tower with useful energy and potential. In like manner the expansive release of oxygen gas upon electrolyzer operation drives out of the electrolyzer under pressure and past the Under this first half of the hydrogen-oxygen conjoined reciprocal electricity generation oscillation, cycle A oxygen inlet valve 950A is open allowing hydrogen gas flowing under pressure from the anode 912 into the hydrogen reciprocating electricity generator 932. This pressurized oxygen gas movement moves the strong magnetic piston inward past the conductive coils for the production of electricity and distribution into the Resource Tower internal electricity network. This movement is possible as cycle A hydrogen outlet valve 952A is open allowing hydrogen gas from the conjoined hydrogen reciprocating electricity generator 930 to exhaust its hydrogen gas from a previous oscillation. As the oxygen strong magnet piston is pushed inward the connected hydrogen strong magnetic piston is pushed outward past its conductive coils for electricity production. The electricity generated is delivered into the Resource Tower internal electricity network for use or distribution. The hydrogen gas is pushed under positive displacement pressure in front of the hydrogen reciprocal electricity generator's strong magnetic piston. The hydrogen is distributed into the hydrogen conduit 980 and throughout the Resource Tower with useful energy and potential. An important feature of the hydrogen-oxygen conjoined reciprocal electricity generator is the larger chambered hydrogen reciprocal electricity generators 920 and 930. The larger chambers accommodate the double volume of hydrogen gas to the single volume of oxygen gas. This design allows the hydrogen reciprocating electricity generator strong magnetic piston to move through the same stroke distance as the oxygen reciprocating electricity generator strong magnetic piston. So, although there is unequal production of hydrogen gas and oxygen gas, there is equivalent hydrogen gas and oxygen gas pressure throughout the Resource Tower hydrogen conduit 980 and oxygen conduit 990. The individual and paired synchronized oscillating operation of the hydrogen-oxygen conjoined reciprocal electricity generators is orchestrated by processors, code, and controls readily available by persons having ordinary skill in those arts. Although the hydrogen-oxygen conjoined reciprocating electricity generator is not central to the Resource Tower, may be substituted by other electricity generators or pumping devices, it is itself an advancement and provides valued additional electricity and positive displacement gas pressure and flow throughout the Resource Tower.

FIG. 10 is a flow diagram of the second oscillation cycle of the hydrogen-oxygen conjoined electricity generators. It follows the same pattern as that described in FIG. 9, but in the opposite direction. By synchronized oscillation by processor, code, and controls cycle B of the hydrogen-oxygen conjoined reciprocal electricity generators occurs. The cycle B hydrogen inlet valve 1060B, cycle B oxygen outlet valve, cycle B oxygen inlet valve 1070B, and cycle B hydrogen outlet valve are simultaneously opened. Also simultaneously closed are cycle A hydrogen inlet valve 1040A, cycle A oxygen outlet valve 1042A, cycle A oxygen inlet valve 1050A, and cycle A hydrogen outlet valve 1052A. Under these conditions hydrogen gas moves under initial pressure into the hydrogen reciprocating electricity generator 1030 and moves the strong magnetic piston past the associated conductive coils for electricity generation. The conjoined oxygen strong magnetic piston moves outward past its associated conductive coils through the conjoined oxygen reciprocating electricity generator 1032. By this action oxygen from a previous oscillation cycle moves outward in front of the oxygen strong magnet piston in a positive displacement creating positive oxygen pressure and flow into the oxygen conduit 1090 and throughout the Resource Tower. In like manner and simultaneously oxygen gas moves under initial pressure into the oxygen reciprocating electricity generator 1022 and moves the strong magnetic piston past the associated conductive coils for electricity generation. The conjoined hydrogen strong magnetic piston moves outward past its associated conductive coils through the conjoined hydrogen reciprocating electricity generator 1020. By this action hydrogen from a previously oscillation cycle moves outward in front of the hydrogen strong magnet piston in a positive displacement creating positive hydrogen pressure and flow into the hydrogen conduit 1080 and throughout the Resource Tower. Between the actions described between FIG. 9 and FIG. 10 a complete cycle is described of the hydrogen-oxygen conjoined reciprocal electricity generators. A complete cycle ultimately creates a continuous positive pressure and flow of hydrogen gas and oxygen gas throughout the Resource Tower. It also contribute to the electricity generation of the Resource Tower to overcome the water electrolysis electricity penalty and ultimately the net electricity generation of the Resource Tower to under developed and developed villages and communities across the globe where the Resource Tower will be deployed for supplemental and alternative electricity generation and water supply.

The processors, code, and controls for input stimulus, in situ systems, and distribution represent the electronic, electrical, interfaces, controlling code, motors, actuators, electromechanical systems, and mechanical systems, gas flow and management, water flow and management, heat flow and management, steam generation and management, monitoring, safety systems, and all other processes, code, and controls required and inherent to a manufacturing and production system like that of the Resource Tower. These systems are used by the Resource Tower, but are not part of the inventive advancements and new social benefits. As such, the Resource Tower relies upon current available components and service by people having ordinary skill in the art of processors, codes, and controls to bring all necessary system operations, management, distribution, safety, and other prudent manufacturing and production considerations.

While the invention has been described with reference to the preferred embodiment thereof, it will be appreciated b those of ordinary skill in the art that modification s can be made to the structure, components used, component and structure positioning (except for the hydrogen and oxygen reactor being place at a height) without departing from the spirit and scope of the invention as a whole.

The present disclosures are described in sufficient detail that it will be apparent to those skilled in the relevant art to make and perform the disclosure. It will also be apparent to the same that some aspects of the disclosure contained commonly understood features that need no detailed description and are not given to retain clarity and focus on the disclosed advancement of the Resource Tower. Other features of the Resource Tower are included to show its uses or adaptability, but these features are not within the thrust of the invention, and will not be described in detail for the sake of clarity around what is being claimed. Disclosed are examples of the Resource Tower, and these examples are not intended to be limiting as to the adaptability and flexibility of the Resource Tower while remaining protected with the stated claims. It will be apparent to people having ordinary skill in the art that such adaptations and variations of the Resource Tower as shown and not shown are within the spirit and the letter of what is claimed as the ownership and protection rights of the Resource Tower and what is disclosed.

### Common Elements, Terminology, and Definitions

Below is listed the terms of this disclosure provided a consolidated manner for ease of location and understanding. The terms and definitions below are not so much to provide a new definition inconsistent with what is known popularly or technically among people having ordinary skill in the art, but more for clarification and ease of access. It will be clear where a definition listed below seeks to uniquely define a word, term, or phrase and where known definitions remain supportive. Small variation of words, terms, and phrases may exist and it will be clear to which formal word, term, or phrase to which they relate and to which it is intended that they have a similar meaning. Where the definition in whole or part is consistent with understanding of what is commonly accepted as the definition of the word, term, or phrase then that definition is also supportive. Unless specifically identified, the terms below should be interpreted by both their generally understood meaning and adapted within the envelope of that understanding to the context in which the words, terms, or phrases are used. Where there may be a conflict between general meaning and specific definition and there is no intuitive bridge, then the specific definition will take precedent.

Component—This term or concept, a variation or an equivalent, and their plural forms means

Controls—This term or concept, a variation or an equivalent, and their plural forms means at least one microprocessor unit configured to control at least one operation of the shoe, at least one battery configured to provide a power supply voltage, and at least one Radio Frequency (RF) unit configured to communicate with at least one external electronic device using at least one wireless communication protocol.

Dirty Water—This term or concept, a variation or an equivalent, and their plural forms represents any supply of water whether from original or post-use sources such as household use, sewage, agricultural use, industrial use, having a salt content from a sea or ocean, or being from other natural sources. Dirty water represents both originally nonpotable and potable water sources.

Dirty Water Reservoir—This term or concept, a variation or an equivalent, and their plural forms means the container of water held for supply to the gas generator. The particulars of the water storage are not critical to the invention, except that the water provided to the gas generator would be screened and filtered to remove any debris or contaminates that would foul the gas generator. Whether the process of preparing dirty water for use in the gas generator is accomplished by the Dirty Water Reservoir or the Gas Generator is not material to the invention.

Dirty Water Supply—This term or concept, a variation or an equivalent, and their plural forms means any conveyance of water into the Dirty Water Reservoir is sufficient. The conveyance of water to the Resource Tower is not within the scope of the invention, but only that there is access to water sufficient to support the operation of the Resource Tower.

Electric Cells—This term or concept, a variation or an equivalent, and their plural forms means One or more Hydrogen Gas and Oxygen Gas based fuel cells, gas combustion engines, or other devices that convert Hydrogen Gas and Oxygen Gas to at least electricity and water, either directly or indirectly. Any potential heat produced will also be considered a source of direct or indirect energy generation from the Resource Tower's total production. The specific operation of the Electric Cell is not the subject of this patent, but that an Electric Cell is present to produce electricity and water from the combination of Hydrogen Gas and Oxygen Gas. The Resource Tower expects to interchange Electric Cells as they improve in efficiency, change in social acceptance, produce more electricity for gas input, economic considerations, and more.

Features—This term or concept, a variation or an equivalent, and their plural forms means

Fuel Cell—This term or concept, a variation or an equivalent, and their plural forms means A device of an oxidant chamber, a conductive membrane or bridge to an ionic or charge molecular reactant, and a fuel chamber, with chambers externally and electrically connected that allows the continuous change in chemical reactivity of a separated fuel and oxidant to produce electrical energy. The oxidant varies by fuel cell design, but commonly is oxygen based. The fuels also vary by fuel cell design and fuel availability and can include hydrogen, methane, propane, methanol, diesel fuel or gasoline. The preferred and best modes of this invention focus on O₂ oxygen gas and H₂ hydrogen gas produced through the electrolysis of water.

Fuel Cell Bank—This term or concept, a variation or an equivalent, and their plural forms means an abbreviated description of one or more fuel cells combined to increase electrical production to vary voltage and amperage. The use of fuel cell bank is considered to mean fuel cell, fuel cells, and one or more fuel cells, fuel cell banks, or other recognizable variation.

Gas—This term or concept, a variation or an equivalent, and their plural forms means a general term referring to the molecular Hydrogen Gas and molecular Oxygen Gas as individual gases or gases collectively.

Gas Conduits—This term or concept, a variation or an equivalent, and their plural forms means any tubing or piping used to convey hydrogen gas, oxygen gas, or gases separately or combined. The expected use of the Gas Conduits is to convey gases from the gas generator to the top of the Resource Tower. The Gas Conduit is considered to maintain its integrity as a Gas Conduit even with the inclusion of any connections, conduits, and interfaces required of gas flow based electricity generators.

Gas Electricity Generators—This term or concept, a variation or an equivalent, and their plural forms means one or more devices that convert the kinetic energy of flowing gases from the Gas Generator on their way to the elevated Electric Cells to produce electricity. The type, form, and means of Gas Electricity Generator and its interface with the Gas Conduit and flowing gases is not inclusive of the patent, but only that to include none, one, or more gas based electricity generators such that the Resource Tower may produce electricity from gas flows. The Resource Tower fully expects to change the Gas Electricity Generators deployed as they evolve in efficiency, robustness, capacity, or other fact& required by Resource Tower use conditions.

Gas Generator—This term or concept, a variation or an equivalent, and their plural forms means a device that cracks liquid water into the stable molecular forms of hydrogen and oxygen. The gas generator of the current preferred embodiment uses hydrolysis.

Hydrogen Gas—This term or concept, a variation or an equivalent, and their plural forms means a simplified term referring to H₂ or hydrogen gas that is the stable form of hydrogen in gas state. The term hydrogen is inclusive of the general form of H₂ and any intermediates that may simultaneously exists at any point in the conversion to the hydrogen gas and combination with oxygen into water. It also refers to hydrogen gas that is substantially hydrogen, but may have traces of oxygen from the gas generator or other impurities carried from the water source.

Hydrogen Gas Flow Electricity Generation—This term or concept, a variation or an equivalent, and their plural forms means that the flow of hydrogen gas through the hydrogen conduit is a source of energy or kinetic motion from which electricity can be generated. The interface of an electricity generator facilitated by the movement of a stream of gas can be integrated directly into the hydrogen conduit or adjacent to the hydrogen gas conduit where the gas flow powered electricity generator is operated by a full or partial stream of flowing gas and in this case hydrogen gas.

Materials—This term or concept, a variation or an equivalent, and their plural forms means Steel, Concrete, composites, natural materials, as a standalone structure, integrated into other structures, or integrated into natural terrain above and below water sources.

Oxygen Gas—This term or concept, a variation or an equivalent, and their plural forms means a simplified term referring to O₂ or oxygen gas that is the stable form of oxygen in gas state. The term oxygen is inclusive of the general form of O₂ and any intermediates that may simultaneously exists at any point in the conversion to the oxygen gas and combination with hydrogen into water. It also refers to hydrogen gas that is substantially hydrogen, but may have traces of oxygen from the gas generator or other impurities carried from the water source.

Oxygen Gas Flow Electricity Generation—This term or concept, a variation or an equivalent, and their plural forms means that the flow of oxygen gas through the oxygen conduit is a source of energy or kinetic motion from which electricity can be generated. The interface of an electricity generator facilitated by the movement of a stream of gas can be integrated directly into the oxygen conduit or adjacent to the oxygen gas conduit where the gas flow powered electricity generator is operated by a full or partial stream of flowing gas and in this case oxygen gas.

Potable Water—This term or concept, a variation or an equivalent, and their plural forms means Represents water recovered from the energy tower having a purity and cleanliness for safe external and internal human and animal use, as well as other commercial, industrial, agricultural uses, and other uses.

Resource Tower—This term or concept, a variation or an equivalent, and their plural forms means a structure of height that may vary based upon the output demands of the complete device. The Tower is the physical structure that holds energy producing units such as gas flow electricity generators that capture upward gas flow, electricity producing fuel cells that convert hydrogen and oxygen gasses into electrical current, heat, and water; and water flow based electricity generators that capture the downward water from the water produced at the top of the Tower by the fuel cells. The resources of the tower are the production of flowing water for electricity generation and other hydraulic driven uses and the production of purified and potable water for safe human, animal, and other uses. The combination of the physical structure and the resulting useful resources are captured by reference as a Resource Tower.

Water Conduit—This term or concept, a variation or an equivalent, and their plural forms means It is inclusive of water byproduct collection or extraction from fuel cells to any tubing or piping used to convey water down the Resource Tower and deliver that water to the Dirty Water Reservoir, a Potable Water Reservoir, or other direct distribution infrastructure outside the Resource Tower. The Water Conduit is considered to maintain its integrity as a Water Conduit even with the inclusion of any connections, conduits, and interfaces required of water flow based electricity generators.

Water Flow Electricity Generators—This term or concept, a variation or an equivalent, and their plural forms means one or more devices that convert the kinetic energy of flowing water from the Electric Cells as water falls and creates a hydraulic pressure flowing down the Resource Tower. The type, form, and means of Water Flow Electricity Generator and its interface with the Water Conduit and flowing water is not inclusive of the patent, but only that to include none, one, or more water based electricity generators such that the Resource Tower may produce electricity from water flows. The Resource Tower fully expects to change the Water Electricity Generators deployed as they evolve in efficiency, robustness, capacity, or other factor required by Resource Tower use conditions.

### General Interpretation

The following paragraphs are a grouping of common Elements of the Resource Tower, common terminology, and useful definitions to facilitate an organized and clear understanding of the Resource Tower.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The singular forms “a,” “an,” and “the” are intended to include plural forms as well, unless the context clearly dictates otherwise. Thus, for example, reference to “a particle” includes reference to one or more of such materials and reference to “subjecting” refers to one or more such steps.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y” As used herein, phrases such as “from about X to Y” mean “from about X to about Y”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context. References to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

As used herein with respect to an identified property or circumstance, “substantially” refers to a degree of deviation that is sufficiently small so as to not measurably detract from the identified property or circumstance. The exact degree of deviation allowable may in some cases depend on the specific context.

A plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein.

In the figures, proportions, thickness of certain lines, layers, components, elements or features may be exaggerated for clarity.

### Claim Description

This section includes the claims in paragraph form. The claims clearly set out what is owned and claimed. Through an abundance of caution and stratagem the claims are reproduced as written or nearly as written to provide a record in the description.

A double type electricity generating resource tower apparatus comprising an elevated hydrogen and oxygen reactor, a hydrogen conduit, a water conduit, and a water flow electricity generation. One or more water electrolyzer(s) as hydrogen gas source and oxygen gas source. One or more said hydrogen and oxygen reactor(s) being fuel cell(s). One or more said hydrogen conduit(s) connecting the hydrogen gas source with the hydrogen and oxygen reactor. One or more said hydrogen and oxygen reactor having post-reaction water recovery, and one or more water conduit to direct water flow and acceleration, one or more water flow electricity generator(s) with electricity distribution in line or adjacently connected to said water conduits.

The resource tower method comprising double type electricity generating, having an elevated hydrogen and oxygen reactor, having a hydrogen conduit, having a water conduit, and having a water flow electricity generation; having one or more water electrolyzer(s) as hydrogen gas source and oxygen gas source; having one or more said hydrogen and oxygen reactor(s) being fuel cell(s); having one or more said hydrogen conduit(s) connecting the hydrogen gas source with the hydrogen and oxygen reactor; having one or more said hydrogen and oxygen reactor(s) having post-reaction water recovery; having one or more water conduit converter(s) being water flow electricity generator(s) and distribution in line or adjacently connected to water conduit.

A quadruple type electricity generating resource tower apparatus comprising: an elevated hydrogen and oxygen reactor, a hydrogen conduit, a hydrogen gas flow electricity generation, an oxygen conduit, an oxygen gas flow electricity generation, a water vaporizer, a water vapor gas flow electricity generation, a water conduit, and a water flow electricity generation. One or more water electrolyzer(s) as hydrogen gas source and oxygen gas source. One or more said hydrogen and oxygen reactor(s) being fuel cell(s). One or more said hydrogen conduit(s) connecting the hydrogen gas source with the hydrogen and oxygen reactor, and one or more said hydrogen gas flow driven electricity generator(s) with electricity distribution in line or adjacently connected to the hydrogen conduit. One or more said oxygen conduit(s) connects the oxygen gas source with the said hydrogen and oxygen reactor, and one or more said oxygen conduit converter(s) being oxygen gas flow driven electricity generator(s) with distribution in line or adjacently connected to the oxygen conduit. One or more said hydrogen and oxygen reactors having post-reaction thermal energy recovery, one or more flash steam converter(s) to form energized water vapor steam using said post-reaction thermal energy, and one or more energized water vapor steam electricity generators with electricity distribution, one or more steam collector(s) with steam condensor(s) coalescing energized water vapor steam to water and delivery to the said flash steam converter(s). One or more said hydrogen and oxygen reactor having post-reaction water recovery, one or more water conduit converter(s) being water flow electricity generator(s) with distribution in line or adjacently connected to the water conduit. One or more heat manifold(s) collecting post-reaction thermal energy from post steam electricity generator use, one or more thermal energy conduit(s) collecting said energized water vapor steam post-use thermal energy, one or more thermal energy transfer jackets adjacent to the said hydrogen conduit(s), one or more thermal energy transfer jackets adjacent to the said oxygen conduit(s), and one or more thermal energy transfer jackets adjacent to the said water electrolyzer(s). The said water delivered to the said water electrolyzer(s). The said water delivered externally. The said electricity generation being used internally, and the said electricity generation being delivered externally.

The resource tower of comprising the method of quadruple type electricity generating, having an elevated hydrogen and oxygen reactor, having a hydrogen conduit, having a hydrogen gas flow electricity generation, having an oxygen conduit, having an oxygen gas flow electricity generation, having a water vaporizer, having a water vapor gas flow electricity generation, having a water conduit, and having a water flow electricity generation; having one or more water electrolyzer(s) as hydrogen gas source and oxygen gas source; having one or more said hydrogen and oxygen reactor(s) being fuel cell(s); having one or more said hydrogen conduit(s) connecting the hydrogen gas source with the hydrogen and oxygen reactor; having one or more said hydrogen conduit converter(s) being hydrogen gas flow driven electricity generator(s) and distribution in line or adjacently connected; having one or more said oxygen conduit(s) connects the oxygen gas source with the said hydrogen and oxygen reactor; having one or more said oxygen conduit converter(s) being oxygen gas flow driven electricity generator(s) and distribution in line or adjacently connected; having one or more said hydrogen and oxygen reactor having post-reaction thermal energy recovery; having one or more said hydrogen and oxygen reactor having post-reaction water recovery; having the combination of said thermal energy recovery and said water recovery to form energized water vapor steam; having one or more said water vapor converter driven by said energized water vapor steam for electricity generation and distribution; having one or more water conduit(s) collecting said energized water vapor steam post-use vapor for coalescence into water; having one or more water conduit converter(s) being water flow driven electricity generator(s) and distribution in line or adjacently connected; having one or more thermal energy conduit(s) collecting said energized water vapor steam post-use thermal energy; having one or more thermal energy transfer jackets adjacent to the said hydrogen conduit(s); having one or more thermal energy transfer jackets adjacent to the said oxygen conduit(s); having one or more thermal energy transfer jackets adjacent to the said water electrolyzer(s); having the said water delivered to the said water electrolyzer(s); having the said water delivered externally; having the said electricity generation being used internally; and having the said electricity generation being delivered externally.

A reciprocating electricity generator apparatus comprising :a chamber lined with one or more circumferential conductors, a piston with magnetic properties, a valve adjacent to each end of the chamber that oppositely cycles between inlet and outlet. The said circumferential conductors having multiple layers of wire with accessible wire ends. Two connected said reciprocating electricity generators called conjoined reciprocating electricity generators. No valves between the reciprocating electricity generators. One double the volume of the other conjoined reciprocating electricity generator. A magnetic piston sized for the internal diameter of each conjoined reciprocating electricity generator and the pistons being rigidly connected.

A reciprocating electricity generator method comprising a method having a chamber lined with one or more circumferential conductors, having a piston with magnetic properties, having a valve adjacent to each end of the chamber that oppositely cycles between inlet and outlet; having said circumferential conductors being multiple layers of wire with accessible wire ends; having two connected said reciprocating electricity generators called conjoined reciprocating electricity generators; having no valves between the reciprocating electricity generators; having one double the volume of the other conjoined reciprocating electricity generator; having a magnetic piston sized for the internal diameter of each conjoined reciprocating electricity generator and the pistons being rigidly connected.

1. A double type electricity generating resource tower apparatus comprising:
an elevated hydrogen and oxygen reactor,
a hydrogen conduit,
a water conduit, and
a water flow electricity generation.

2. The resource tower of claim 1, comprising one or more water electrolyzer(s) as hydrogen gas source and oxygen gas source.

3. The resource tower of claim 1, comprising one or more said hydrogen and oxygen reactor(s) being fuel cell(s).

4. The resource tower of claim 1, comprising one or more said hydrogen conduit(s) connecting the hydrogen gas source with the hydrogen and oxygen reactor.

5. The resource tower of claim 1, comprising
one or more said hydrogen and oxygen reactor having post-reaction water recovery, and
one or more water conduit to direct water flow and acceleration,
one or more water flow electricity generator(s) with electricity distribution in line or adjacently connected to said water conduits.

6. The resource tower method comprising double type electricity generating, having an elevated hydrogen and oxygen reactor, having a hydrogen conduit, having a water conduit, and having a water flow electricity generation; having one or more water electrolyzer(s) as hydrogen gas source and oxygen gas source; having one or more said hydrogen and oxygen reactor(s) being fuel cell(s); having one or more said hydrogen conduit(s) connecting the hydrogen gas source with the hydrogen and oxygen reactor; having one or more said hydrogen and oxygen reactor(s) having post-reaction water recovery; having one or more water conduit converter(s) being water flow electricity generator(s) and distribution in line or adjacently connected to water conduit.

7. A quadruple type electricity generating resource tower apparatus comprising:
an elevated hydrogen and oxygen reactor,
a hydrogen conduit,
a hydrogen gas flow electricity generation,
an oxygen conduit,
an oxygen gas flow electricity generation,
a water vaporizer,
a water vapor gas flow electricity generation,
a water conduit, and
a water flow electricity generation.

8. The resource tower of claim 7, comprising one or more water electrolyzer(s) as hydrogen gas source and oxygen gas source.

9. The resource tower of claim 7, comprising one or more said hydrogen and oxygen reactor(s) being fuel cell(s).

10. The resource tower of claim 7, comprising:
one or more said hydrogen conduit(s) connecting the hydrogen gas source with the hydrogen and oxygen reactor, and
one or more said hydrogen gas flow driven electricity generator(s) with electricity distribution in line or adjacently connected to the hydrogen conduit.

11. The resource tower of claim 7, comprising:
one or more said oxygen conduit(s) connects the oxygen gas source with the said hydrogen and oxygen reactor, and
one or more said oxygen conduit converter(s) being oxygen gas flow driven electricity generator(s) with distribution in line or adjacently connected to the oxygen conduit.

12. The resource tower of claim 7, comprising:
one or more said hydrogen and oxygen reactors having post-reaction thermal energy recovery,
one or more flash steam converter(s) to form energized water vapor steam using said post-reaction thermal energy, and
one or more energized water vapor steam electricity generators with electricity distribution, and
one or more steam collector(s) with steam condensor(s) coalescing energized water vapor steam to water and delivery to the said flash steam converter(s).

13. The resource tower of claim 7, comprising:
one or more said hydrogen and oxygen reactor having post-reaction water recovery,
one or more water conduit converter(s) being water flow electricity generator(s) with distribution in line or adjacently connected to the water conduit.

14. The resource tower of claim 7, comprising:
one or more heat manifold(s) collecting post-reaction thermal energy from post steam electricity generator use,
one or more thermal energy conduit(s) collecting said energized water vapor steam post-use thermal energy,
one or more thermal energy transfer jackets adjacent to the said hydrogen conduit(s),
one or more thermal energy transfer jackets adjacent to the said oxygen conduit(s), and
one or more thermal energy transfer jackets adjacent to the said water electrolyzer(s).

15. The resource tower of claim 7, comprising the said water delivered to the said water electrolyzer(s).

16. The resource tower of claim 7, comprising the said water delivered externally.

17. The resource tower of claim 7, comprising:
the said electricity generation being used internally, and
the said electricity generation being delivered externally.

18. The resource tower of claim 7, comprising the method of quadruple type electricity generating, having an elevated hydrogen and oxygen reactor, having a hydrogen conduit, having a hydrogen gas flow electricity generation, having an oxygen conduit, having an oxygen gas flow electricity generation, having a water vaporizer, having a water vapor gas flow electricity generation, having a water conduit, and having a water flow electricity generation; having one or more water electrolyzer(s) as hydrogen gas source and oxygen gas source; having one or more said hydrogen and oxygen reactor(s) being fuel cell(s); having one or more said hydrogen conduit(s) connecting the hydrogen gas source with the hydrogen and oxygen reactor; having one or more said hydrogen conduit converter(s) being hydrogen gas flow driven electricity generator(s) and distribution in line or adjacently connected; having one or more said oxygen conduit(s) connects the oxygen gas source with the said hydrogen and oxygen reactor; having one or more said oxygen conduit converter(s) being oxygen gas flow driven electricity generator(s) and distribution in line or adjacently connected; having one or more said hydrogen and oxygen reactor having post-reaction thermal energy recovery; having one or more said hydrogen and oxygen reactor having post-reaction water recovery; having the combination of said thermal energy recovery and said water recovery to form energized water vapor steam; having one or more said water vapor converter driven by said energized water vapor steam for electricity generation and distribution; having one or more water conduit(s) collecting said energized water vapor steam post-use vapor for coalescence into water; having one or more water conduit converter(s) being water flow driven electricity generator(s) and distribution in line or adjacently connected; having one or more thermal energy conduit(s) collecting said energized water vapor steam post-use thermal energy; having one or more thermal energy transfer jackets adjacent to the said hydrogen conduit(s); having one or more thermal energy transfer jackets adjacent to the said oxygen conduit(s); having one or more thermal energy transfer jackets adjacent to the said water electrolyzer(s); having the said water delivered to the said water electrolyzer(s); having the said water delivered externally; having the said electricity generation being used internally; and having the said electricity generation being delivered externally.

19. A reciprocating electricity generator apparatus comprising:
a chamber lined with one or more circumferential conductors,
a piston with magnetic properties,
a valve adjacent to each end of the chamber that oppositely cycles between inlet and outlet.

20. The reciprocating electricity generator apparatus of claim 19 comprising said circumferential conductors being multiple layers of wire with accessible wire ends.

21. The reciprocating electricity generator apparatus of claim 19 comprising two connected said reciprocating electricity generators called conjoined reciprocating electricity generators.

22. The said conjoined reciprocating electricity generators of claim 21 comprising no valves between the reciprocating electricity generators.

23. The said conjoined reciprocating electricity generators of claim 22 comprising one double the volume of the other conjoined reciprocating electricity generator.

24. The said conjoined reciprocating electricity generators of claim 23 comprising a magnetic piston sized for the internal diameter of each conjoined reciprocating electricity generator and the pistons being rigidly connected.

25. A reciprocating electricity generator method comprising a method having a chamber lined with one or more circumferential conductors, having a piston with magnetic properties, having a valve adjacent to each end of the chamber that oppositely cycles between inlet and outlet; having said circumferential conductors being multiple layers of wire with accessible wire ends; having two connected said reciprocating electricity generators called conjoined reciprocating electricity generators; having no valves between the reciprocating electricity generators; having one double the volume of the other conjoined reciprocating electricity generator; having a magnetic piston sized for the internal diameter of each conjoined reciprocating electricity generator and the pistons being rigidly connected.
